(19) United States
(12) Patent Application Publication
(10) Pub. No.: US 2023/0115050 A1
(43) Pub. Date: Apr. 13, 2023

(54) THERMALLY CONDUCTIVE AND ELECTRICALLY INSULATING POWDER COATING COMPOSITIONS

(71) Applicant: PPG Industries Ohio, Inc., Cleveland, OH (US)

(72) Inventors: Liang Ma, Allison Park, PA (US); Calum H. Munro, Gibsonia, PA (US); Marvin M. Pollum, JR., Pittsburgh, PA (US); Daniel K. Dei, Pittsburgh, PA (US); Brian E. Woodworth, Glenshaw, PA (US); John R. Schneider, Allison Park, PA (US); Maria S. French, Berkshire (GB); Allison G. Condie, Valencia, PA (US); Holli A. Gonder-Jones, Akron, OH (US); Christopher Apanius, Moreland Hills, OH (US); Cassandra Noelle Bancroft, Fairview Park, OH (US)

(73) Assignee: PPG Industries Ohio, Inc., Cleveland, OH (US)

(21) Appl. No.: 17/905,039

(22) PCT Filed: Feb. 26, 2021
(86) PCT No.: PCT/US2021/019831

§ 371 Date: Aug. 25, 2022

Related U.S. Application Data
(60) Provisional application No. 62/981,741, filed on Feb. 26, 2020.

(51) Int. Cl. C09K 5/14; C09D 167/00; C09D 7/63; C09D 7/61; C09D 5/03; C09D 5/18

(52) U.S. Cl. CPC C09K 5/14; C09D 167/00; C09D 7/63; C09D 7/61; C09D 5/033; C09D 5/18; C09D 5/031; H01M 10/653

(57) ABSTRACT

The present invention is directed towards a powder coating composition comprising a binder; a thermally conductive, electrically insulative filler material; and, optionally, a thermoplastic material and/or a core-shell polymer. The present invention is also directed to a substrate comprising a coating layer deposited from the powder coating composition of the present invention, as well as methods of coating a substrate.

### FIELD OF THE INVENTION

The present invention is directed towards thermally conductive, electrically insulating powder coating compositions, methods of coating substrates, and coated substrates.

### BACKGROUND INFORMATION

Substrates, such as metal substrates including metal electrical components and batteries, are often protected with a high dielectric strength material to provide insulating properties. For example, components have been coated with a dielectric tapes and coatings to provide insulating properties. While dielectric tapes and coatings can provide insulating properties, they can be difficult to apply uniformly to substrates. In addition, it can be difficult to obtain good insulating properties at low coating film thicknesses. In addition, battery components can produce heat during use, and insulating tapes and coatings often have difficulty dissipating such heat by conducting it away from the underlying substrate. Thus, it is desirable to develop improved dielectric coatings that provide good electrical insulation and that provide improved thermal conductivity.

### SUMMARY OF THE INVENTION

Disclosed herein is a powder coating composition comprising a binder; a thermally conductive, electrically insulative filler material; and a thermoplastic material and/or core-shell polymer.

Also disclosed herein is a powder coating composition comprising a binder; and at least two thermally conductive, electrically insulative filler materials.

Further disclosed herein are a substrate comprising a coating layer deposited from a powder coating composition of the present invention.

Still further disclosed herein are a battery component comprising a thermally conductive, electrically insulating coating comprising a binder; and aluminum hydroxide present in an amount of at least 40% by weight, based on the total weight of the thermally conductive, electrically insulating coating.

### DETAILED DESCRIPTION OF THE INVENTION

As stated above, the present invention is directed to a powder coating composition comprising a binder and a thermally conductive, electrically insulative filler material. As used herein, a “powder coating composition” refers to a coating composition embodied in solid particulate form as opposed to liquid form.

According to the present invention, the powder coating composition comprises a binder. As used herein, a “binder” refers to a constituent, film-forming material that holds all coating composition components together in a coating layer upon cure. The binder comprises one or more film-forming resins that can be used to form the coating layer. As used herein, a “film-forming resin” refers to a resin that can form a self-supporting continuous film on at least a horizontal surface of a substrate. The term “resin” is used interchangeably with “polymer,” and the term polymer refers to oligomers, homopolymers (e.g., prepared from a single monomer species), copolymers (e.g., prepared from at least two monomer species), terpolymers (e.g., prepared from at least three monomer species), and graft polymers.

The powder coating compositions used with the present invention can include any of a variety of thermosetting powder coating compositions known in the art. As used herein, the term “thermosetting” refers to compositions that “set” irreversibly upon curing or crosslinking, wherein polymer chains of polymeric components are joined together by covalent bonds. This property is usually associated with a cross-linking reaction of the composition constituents often induced, for example, by heat or radiation. Once cured or crosslinked, a thermosetting resin will not melt upon the application of heat and is insoluble in most solvents.

The powder coating compositions used with the present invention can also include thermoplastic powder coating compositions. As used herein, the term “thermoplastic” refers to compositions that include polymeric components that are not joined by covalent bonds after baking to form a coating and, thereby, can undergo liquid flow upon heating without crosslinking.

Non-limiting examples of suitable film-forming resins that form at least a portion of the binder of the powder coating composition include (meth)acrylate resins, polyurethanes, polyesters, polyamides, polyethers, polysiloxanes, epoxy resins, vinyl resins, copolymers thereof and combinations thereof. As used herein, “(meth)acrylate” and like terms refers both to the acrylate and the corresponding methacrylate. Further, the film-forming resins can have any of a variety of functional groups including, but not limited to, carboxylic acid groups, amine groups, epoxide groups, hydroxyl groups, thiol groups, carbamate groups, amide groups, urea groups, isocyanate groups (including blocked isocyanate groups), ethylenically unsaturated groups, and combinations thereof. As used herein, “ethylenically unsaturated” refers to a group having at least one carbon-carbon double bond. Non-limiting examples of ethylenically unsaturated groups include, but are not limited to, (meth)acrylate groups, vinyl groups, and combinations thereof.

Thermosetting coating compositions typically comprise a crosslinker that may be selected from any of the crosslinkers known in the art to react with the functionality of one or more film-forming resins used in the powder coating composition. As used herein, the term “crosslinker” refers to a molecule comprising two or more functional groups that are reactive with other functional groups and that is capable of linking two or more monomers or polymers through chemical bonds. Alternatively, the film-forming resins that form the binder of the powder coating composition can have functional groups that are reactive with themselves; in this manner, such resins are self-crosslinking.

Non-limiting examples of crosslinkers include phenolic resins, amino resins, epoxy resins, triglycidyl isocyanurate, beta-hydroxy (alkyl) amides, alkylated carbamates, (meth)acrylates, salts of poly carboxylic acids with cyclic amidine, o-tolyl biguanide, isocyanates, blocked isocyanates, polyacids, anhydrides, organometallic acid-functional materials, polyamines, polyamides, aminoplasts, carbodiimides, oxazolines, and combinations thereof.

As mentioned above, the binder of the powder coating composition may comprise one or more film-forming resins and one or more crosslinkers. A binder that comprises two or more film-forming resins may be referred to as a hybrid binder. For example, the film-forming resin of the binder may comprise, consist essentially of, or consist of at least two of (meth)acrylate resins, polyurethanes, polyesters, polyamides, polyethers, polysiloxanes, epoxy resins, vinyl resins, or copolymers thereof. In addition, the binder may comprise a crosslinker comprising, consisting essentially of, or consisting of one of or a combination of phenolic resins, amino resins, epoxy resins, triglycidyl isocyanurate, beta-hydroxy (alkyl) amides, alkylated carbamates, (meth)acrylates, salts of poly carboxylic acids with cyclic amidine, o-tolyl biguanide isocyanates, blocked isocyanates, polyacids, anhydrides, organometallic acid-functional materials, polyamines, polyamides, aminoplasts, carbodiimides, or oxazolines.

Alternatively, the binder of the powder coating composition may comprise, consist essentially of, or consist of a single film-forming resin. For example, the film-forming resin of the binder may comprise, consist essentially of, or consist of one of (meth)acrylate resins, polyurethanes, polyesters, polyamides, polyethers, polysiloxanes, epoxy resins, vinyl resins, or copolymers thereof, without a second resin present that is different than the first resin. In addition, the binder may comprise a crosslinker comprising, consisting essentially of, or consisting of one of or a combination of phenolic resins, amino resins, epoxy resins, triglycidyl isocyanurate, beta-hydroxy (alkyl) amides, alkylated carbamates, (meth)acrylates, isocyanates, blocked isocyanates, polyacids, anhydrides, organometallic acid-functional materials, polyamines, polyamides, aminoplasts, carbodiimides, or oxazolines.

The binder of the powder coating composition may comprise, consist essentially of, or consist of film-forming resins having the same reactive functionality. For example, the film-forming resin may comprise two or more epoxy functional film-forming resins.

The film-forming resin may be present in the binder in an amount of at least 10% by weight, such as at least 20% by weight, at least 30% by weight, or at least 40% by weight, based on the total weight of the binder. The film-forming resin can be present in the binder in an amount of up to 97% by weight, such as up to 80% by weight, such as up to 60% by weight, such as up to 50% by weight, based on the total weight of the binder. The film-forming resin may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder.

The film-forming resin may comprise a single film-forming resin comprising may comprise, consist essentially of, or consist of one of (meth)acrylate resins, polyurethanes, polyesters, polyamides, polyethers, polysiloxanes, epoxy resins, vinyl resins, or copolymers thereof in an amount of at least 10 weight %, at least 20 weight %, at least 30 weight %, or at least 40 weight % of the powder coating composition, based on the total weight of the binder. The film-forming resin may comprise a single film-forming resin comprising may comprise, consist essentially of, or consist of one of (meth)acrylate resins, polyurethanes, polyesters, polyamides, polyethers, polysiloxanes, epoxy resins, vinyl resins, or copolymers thereof in an amount of up to 97% by weight, such as up to 80% by weight, such as up to 60 weight %, such as up to 50 weight % of the powder coating composition, based on the total weight of the binder. The film-forming resin may comprise a single film-forming resin comprising may comprise, consist essentially of, or consist of one of (meth)acrylate resins, polyurethanes, polyesters, polyamides, polyethers, polysiloxanes, epoxy resins, vinyl resins, or copolymers thereof in an amount of from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder.

The crosslinker may be present in the binder an amount of at least 3% by weight, such as at least 10% by weight, such as at least 20% by weight, such as at least 30% by weight, such as at least 40% by weight, based on the total weight of the binder. The crosslinker may be present in the binder an amount of up to 70 weight %, such as up to 60 weight %, such as up to 50 weight %, such as up to 40% by weight, based on the total weight of the binder. The crosslinker may be present in the binder an amount of from 3% to 70% by weight, such as 3% to 60% by weight, such as 3% to 50% by weight, such as 3% to 40% by weight, such as 10% to 70% by weight, such as 10% to 60% by weight, such as 10% to 50% by weight, such as 10% to 40% by weight, such as 30% to 70% by weight, such as 30% to 60% by weight, such as 30% to 50% by weight, such as 30% to 40% by weight, such as 40% to 70% by weight, such as 40% to 60% by weight, such as 40% to 50% by weight, based on the total weight of the binder.

A non-limiting example of a hybrid binder of the powder coating composition is a binder comprising: (a) an epoxy functional polymer; (b) a poly-carboxylic acid functional polyester polymer reactive with the epoxy functional polymer and which comprises an acid value of less than 100 mg KOH/g; and (c) a poly-carboxylic acid functional (meth)acrylate polymer reactive with the epoxy functional polymer. It is appreciated that the epoxy functional polymer, poly-carboxylic acid functional polyester polymer, and poly-carboxylic acid functional (meth)acrylate polymer can react to form a hydroxyl functional reaction product.

As used herein, a “poly-carboxylic acid functional polymer” refers to a polymer having two or more carboxylic acid functional groups. The poly-carboxylic acid functional polyester polymer used in the powder coating composition of the present invention can have an acid value of less than 100 mg KOH/g or less than 80 mg KOH/g. The poly-carboxylic acid functional polyester polymer can further have an acid value of at least 60 mg KOH/g. The poly-carboxylic acid functional polyester polymer can also have, for example, an acid value of from 60 mg KOH/g to 100 mg KOH/g, or from 60 mg KOH/g to 80 mg KOH/g. The poly-carboxylic acid functional polyester polymer can be formed from various materials such as poly(ethylene terephthalate) for example.

The poly-carboxylic acid functional polyester polymer can comprise at least 20 weight %, at least 25 weight %, at least 30 weight %, at least 35 weight %, or at least 40 weight % of the powder coating composition, based on the total solids weight of the powder coating composition. The poly-carboxylic acid functional polyester polymer can comprise up to 97 weight % or up to 60 weight % or up to 50 weight % of the powder coating composition, based on the total solids weight of the powder coating composition. The poly-carboxylic acid functional polyester polymer can also comprise an amount within a range such as from 20 to 97 weight % or from 20 to 60 weight % or from 30 to 50 weight % of the powder coating composition, based on the total solids weight of the powder coating composition.

As indicated, the powder coating composition also comprises a poly-carboxylic acid functional (meth)acrylate polymer. The poly-carboxylic acid functional (meth)acrylate polymer can comprise at least 0.05 weight %, at least 0.1 weight %, at least 0.5 weight %, at least 1 weight %, or at least 2 weight % of the powder coating composition, based on the total solids weight of the powder coating composition. The poly-carboxylic acid functional (meth)acrylate polymer can comprise up to 10 weight %, up to 5 weight %, or up to 3 weight % of the powder coating composition, based on the total solids weight of the powder coating composition. The poly-carboxylic acid functional (meth)acrylate polymer can also comprise an amount within a range such as from 0.05 to 10 weight %, or from 0.1 to 5 weight %, or from 1 to 3 weight % of the powder coating composition, based on the total solids weight of the powder coating composition.

The poly-carboxylic acid functional polyester polymer and the poly-carboxylic acid functional (meth)acrylate polymer can be combined in the powder coating composition to provide a desired weight ratio. For example, the poly-carboxylic acid functional polyester polymer and the poly-carboxylic acid functional (meth)acrylate polymer can be combined in the powder coating composition to provide a weight ratio of the poly-carboxylic acid functional polyester polymer to the poly-carboxylic acid functional (meth)acrylate polymer of 1:1 or greater, or 5:1 or greater, or 10:1 or greater, or 15:1 or greater, or 20:1 or greater.

The powder coating composition can also include additional carboxylic acid functional polymers including, but not limited to, carboxylic acid functional polyurethane polymers, polyamide polymers, polyether polymers, polysiloxane polymers, vinyl resins, copolymers thereof, and combinations thereof. Further, any of the previously described carboxylic acid functional polymers can have any of a variety of additional functional groups including, but not limited to, amine groups, hydroxyl groups, thiol groups, carbamate groups, amide groups, urea groups, and combinations thereof. Alternatively, the powder coating composition of the present invention can be free of such additional poly-carboxylic acid functional polymers.

The total amount of carboxylic acid functional polymers can comprise at least 20 weight %, at least 30 weight %, or at least 40 weight % of the powder coating composition, based on the total solids weight of the powder coating composition. The total amount of carboxylic acid functional polymers can comprise up to 70 weight %, up to 60 weight %, or up to 50 weight % of the powder coating composition, based on the total solids weight of the powder coating composition. The total amount of carboxylic acid functional polymers can also comprise an amount within a range such as from 20 to 70 weight %, or from 30 to 60 weight %, or from 40 to 50 weight % of the powder coating composition, based on the total solids weight of the powder coating composition.

The carboxylic acid functional polymers can also be formed from recycled materials. For example, the powder coating composition of the present invention can comprise a poly-carboxylic acid functional polyester prepared from at least one recycled material. A non-limiting example of a recycled material that can be used to form the poly-carboxylic acid functional polyester is recycled poly(ethylene terephthalate).

As previously described, the exemplary powder coating composition of the present invention also comprises an epoxy functional polymer that is reactive with at least the poly-carboxylic acid functional polyester polymer and the poly-carboxylic acid functional (meth)acrylate polymer. It is appreciated that the epoxy functional polymer comprises two or more epoxy functional groups and acts as a crosslinker when reacted with the carboxylic acid functional polymers. Non-limiting examples of suitable epoxy functional polymers include, but are not limited to, diglycidyl ethers of bisphenol A, polyglycidyl ethers of polyhydric alcohols, polyglycidyl esters of polycarboxylic acids, and combinations thereof. Non-limiting examples of suitable epoxy resins are also commercially available from NanYa Plastics under the trade name NPES-903, and from Hexion under the trade names EPON™ 2002 and EPON 2004™.

The epoxy functional polymer can have an equivalent weight of at least 200 or at least 500 or at least 700. The epoxy functional polymer can also comprise an equivalent weight of up to 1000 or up to 5100. The epoxy functional polymer can comprise an equivalent weight within the range of 200 to 5100 or from 200 to 1000 or from 500 to 5100 or from 500 to 1000 or from 700 to 5100 or from 700 to 1000. As used herein, “equivalent weight” refers to the average weight molecular weight of a resin divided by the number of functional groups. As such, the equivalent weight of the epoxy functional polymer is determined by dividing the average weight molecular weight of the epoxy resin by the total number of epoxide groups and any other optional functional groups that are not an epoxide. Further, the average weight molecular weight is determined by gel permeation chromatography relative to linear polystyrene standards of 800 to 900,000 Daltons as measured with a Waters 2695 separation module with a Waters 410 differential refractometer (RI detector). Tetrahydrofuran (THF) is used as the eluent at a flow rate of 1 ml min-1, and two PLgel Mixed-C (300×7.5 mm) columns is used for separation.

It is appreciated that the epoxy functional polymer can comprise one or multiple types of epoxy functional polymers. When multiple epoxy functional polymers are used, the multiple epoxy functional polymers can have the same or different equivalent weights. For instance, a first epoxy functional polymer can have an equivalent weight that is greater than an equivalent weight of a second epoxy functional polymer. The epoxy functional polymers can also include additional functional groups besides the epoxy functional groups including, but not limited to, any of the previously described functional groups. Alternatively, the epoxy functional polymer can be free of any one, or all, of the previously described functional groups besides the epoxy functional groups.

The epoxy functional polymer can comprise at least 10 weight %, at least 20 weight %, at least 30 weight %, or at least 40 weight % of the powder coating composition, based on the total solids weight of the powder coating composition. The epoxy functional polymer can comprise up to 95 weight % or up to 60 weight % or up to 50 weight % of the powder coating composition, based on the total solids weight of the coating composition. The epoxy functional polymer can also comprise an amount within a range such as from 10 to 95 weight %, or from 20 to 60 weight %, or from 30 to 50 weight %, or from 40 to 50 weight % of the powder coating composition, based on the total solids weight of the powder coating composition.

The poly-carboxylic acid functional polyester polymer and the epoxy functional polymer can also be combined in the powder coating composition to provide a desired weight ratio. For example, the poly-carboxylic acid functional polyester polymer and the epoxy functional polymer can be combined in the powder coating composition to provide a weight ratio of the poly-carboxylic acid functional polyester polymer to the epoxy functional polymer of 0.2:1 to 1:1, or from 0.5:1 to 1:0.5, or from 0.8:1 to 1:0.8, or from 0.9:1 to 1:0.9, or from 0.95:1 to 1:0.95, or at a ratio of 1:1.

The carboxylic acid functional polymers and the epoxy functional polymer of the powder coating composition are reacted to form a reaction product comprising hydroxyl functional groups. The reaction product can comprise one or multiple hydroxyl groups. For example, the reaction product can comprise multiple pendant hydroxyl groups and, optionally, terminal hydroxyl groups.

The powder coating composition of the present invention can also comprise, as discussed above, an isocyanate functional crosslinker that is reactive with the previously described reaction product comprising hydroxyl functional groups. The isocyanate crosslinker can provide additional properties including, for example, a higher crosslink density for increased chemical and abrasion resistance.

The isocyanate functional crosslinker can include various types of polyisocyanates. Polyisocyanates that can be used include aliphatic and aromatic diisocyanates as well as higher functional polyisocyanates. Non-limiting examples of suitable polyisocyanates include isophorone diisocyanate (IPDI), dicyclohexylmethane 4,4′-diisocyanate (H12MDI), cyclohexyl diisocyanate (CFIDI), m-tetramethylxylylene diisocyanate (m-TMXDI), p-tetramethylxylylene diisocyanate (p-TMXDI), ethylene diisocyanate, 1,2-diisocyanatopropane, 1,3-diisocyanatopropane, 1,6-diisocyanatohexane (hexam ethylene diisocyanate or FIDI), 1,4-butylene diisocyanate, lysine diisocyanate, 1, 4-methyl ene bis-(cyclohexyl isocyanate), toluene diisocyanate (TDI), m-xylylenediisocyanate (MXDI) and p-xylylenediisocyanate, 4-chloro-1,3-phenyl ene diisocyanate, 1,5-tetrahydro-naphthalene diisocyanate, 4,4′-dibenzyl diisocyanate, and 1,2,4-benzene triisocyanate, xylylene diisocyanate (XDI), and mixtures or combinations thereof.

The isocyanate crosslinker can comprise a blocked isocyanate functional crosslinker. A “blocked isocyanate” refers to a compound with isocyanate functional groups that have been reacted with a blocking agent and which prevents the isocyanate functionality from reacting until the blocking agent is removed upon exposure to an external stimulus such as heat. Non-limiting examples of blocking agents include phenols, pyridinols, thiophenols, methylethylketoxime, amides, caprolactam, imidazoles, and pyrazoles. The isocyanate can also include a uretdione isocyanate such as a uretdione internally blocked isocyanate adduct.

The isocyanate functional crosslinker can comprise at least 0.1 weight %, at least 1 weight %, or at least 3 weight % of the powder coating composition, based on the total solids weight of the powder coating composition. The isocyanate functional crosslinker can comprise up to 50 weight %, up to 30 weight %, up to 20 weight %, up to 10 weight %, up to 8 weight %, or up to 5 weight % of the powder coating composition, based on the total solids weight of the powder coating composition. The isocyanate functional crosslinker can also comprise an amount within a range such as from 0.1 to 50 weight %, or from 0.1 to 30 weight %, or from 0.1 to 20 weight %, or from 0.1 to 10 weight %, or from 0.1 to 8 weight %, or from 0.1 to 5 weight %, or from 1 to 50 weight %, or from 1 to 30 weight %, or from 1 to 20 weight %, or from 1 to 10 weight %, or from 1 to 8 weight %, or from 1 to 5 weight %, or from 3 to 50 weight %, or from 3 to 30 weight %, or from 3 to 20 weight %, or from 3 to 10 weight %, or from 3 to 8 weight %, or from 3 to 5 weight %, based on the total solids weight of the powder coating composition.

A non-limiting example of a binder of the powder coating composition is a binder comprising, consisting essentially of, or consisting of (a) an epoxy functional polymer; and (b) a crosslinker. The epoxy functional polymer may be present in an amount of at least 10% by weight, such as at least 20% by weight, at least 30% by weight, or at least 40% by weight, based on the total weight of the binder. The epoxy functional polymer may be present in the binder in an amount of up to 97% by weight, such as up to 80% by weight, such as up to 60% by weight, such as up to 50% by weight, based on the total weight of the binder. The epoxy functional polymer may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder. The crosslinker may be present in the binder an amount of at least 3% by weight, such as at least 10% by weight, such as at least 20% by weight, such as at least 30% by weight, such as at least 40% by weight, based on the total weight of the binder. The crosslinker may be present in the binder an amount of up to 70 weight %, such as up to 60 weight %, such as up to 50 weight %, such as up to 40% by weight, based on the total weight of the binder. The crosslinker may be present in the binder an amount of from 3% to 70% by weight, such as 3% to 60% by weight, such as 3% to 50% by weight, such as 3% to 40% by weight, such as 10% to 70% by weight, such as 10% to 60% by weight, such as 10% to 50% by weight, such as 10% to 40% by weight, such as 30% to 70% by weight, such as 30% to 60% by weight, such as 30% to 50% by weight, such as 30% to 40% by weight, such as 40% to 70% by weight, such as 40% to 60% by weight, such as 40% to 50% by weight, based on the total weight of the binder.

A non-limiting example of a binder of the powder coating composition is a binder comprising, consisting essentially of, or consisting of (a) polyester resin; and (b) a crosslinker. The polyester resin may be present in an amount of at least 10% by weight, such as at least 20% by weight, at least 30% by weight, or at least 40% by weight, based on the total weight of the binder. The polyester resin may be present in the binder in an amount of up to 97% by weight, such as up to 80% by weight, such as up to 60% by weight, such as up to 50% by weight, based on the total weight of the binder. The polyester resin may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder. The crosslinker may be present in the binder an amount of at least 3% by weight, such as at least 10% by weight, such as at least 20% by weight, such as at least 30% by weight, such as at least 40% by weight, based on the total weight of the binder. The crosslinker may be present in the binder an amount of up to 70 weight %, such as up to 60 weight %, such as up to 50 weight %, such as up to 40% by weight, based on the total weight of the binder. The crosslinker may be present in the binder an amount of from 3% to 70% by weight, such as 3% to 60% by weight, such as 3% to 50% by weight, such as 3% to 40% by weight, such as 10% to 70% by weight, such as 10% to 60% by weight, such as 10% to 50% by weight, such as 10% to 40% by weight, such as 30% to 70% by weight, such as 30% to 60% by weight, such as 30% to 50% by weight, such as 30% to 40% by weight, such as 40% to 70% by weight, such as 40% to 60% by weight, such as 40% to 50% by weight, based on the total weight of the binder.

A non-limiting example of a binder of the powder coating composition is a binder comprising, consisting essentially of, or consisting of (a) a polyester resin; and (b) a crosslinker comprising a polyisocyanate. The polyester resin may be present in an amount of at least 10% by weight, such as at least 20% by weight, at least 30% by weight, or at least 40% by weight, based on the total weight of the binder. The polyester resin may be present in the binder in an amount of up to 97% by weight, such as up to 80% by weight, such as up to 60% by weight, such as up to 50% by weight, based on the total weight of the binder. The polyester resin may be present in the binder an amount from 10% to 97% by weight, such as 10% to 80% by weight, such as 10% to 60% by weight, such as 10% to 50% by weight, such as 20% to 97% by weight, such as 20% to 80% by weight, such as 20% to 60% by weight, such as 20% to 50% by weight, such as 30% to 97% by weight, such as 30% to 80% by weight, such as 30% to 60% by weight, such as 30% to 50% by weight, such as 40% to 97% by weight, such as 40% to 80% by weight, such as 40% to 60% by weight, such as 40% to 50% by weight, based on the total weight of the binder. The polyisocyanate may be present in the binder an amount of at least 3% by weight, such as at least 10% by weight, such as at least 20% by weight, such as at least 30% by weight, such as at least 40% by weight, based on the total weight of the binder. The polyisocyanate may be present in the binder an amount of up to 70 weight %, such as up to 60 weight %, such as up to 50 weight %, such as up to 40% by weight, based on the total weight of the binder. The polyisocyanate may be present in the binder an amount of from 3% to 70% by weight, such as 3% to 60% by weight, such as 3% to 50% by weight, such as 3% to 40% by weight, such as 10% to 70% by weight, such as 10% to 60% by weight, such as 10% to 50% by weight, such as 10% to 40% by weight, such as 30% to 70% by weight, such as 30% to 60% by weight, such as 30% to 50% by weight, such as 30% to 40% by weight, such as 40% to 70% by weight, such as 40% to 60% by weight, such as 40% to 50% by weight, based on the total weight of the binder.

The powder coating compositions can also be substantially free, essentially free, or completely free of any of the previously described film-forming resins and/or crosslinkers. For example, the powder coating composition can be substantially free, essentially free, or completely free of a hydroxyl functional film-forming resin and/or an isocyanate functional crosslinker. The term “substantially free” as used in this context means the powder coating composition contains less than 1000 parts per million (ppm), “essentially free” means less than 100 ppm, and “completely free” means less than 20 parts per billion (ppb) of a certain film-forming resin and/or crosslinker such as a hydroxyl functional film-forming resin and/or an isocyanate functional crosslinker, based on the total weight of the powder coating composition.

The curable powder coating composition of the present invention can be cured with heat, increased or reduced pressure, chemically such as with moisture, or with other means such as actinic radiation, and combinations thereof. The term “actinic radiation” refers to electromagnetic radiation that can initiate chemical reactions. Actinic radiation includes, but is not limited to, visible light, ultraviolet (UV) light, infrared radiation, X-ray, and gamma radiation. As used herein, the terms “curable”, “cure”, and the like, as used in connection with a powder coating composition, means that at least a portion of the components that make up the powder coating composition are polymerizable and/or crosslinkable including self-crosslinkable polymers.

The binder may be present in the powder coating composition in an amount of at least 10% by weight, such as at least 20% by weight, such as at least 40% by weight, such as at least 50% by weight, such as at least 60% by weight, based on the total weight of the powder coating composition. The binder may be present in the powder coating composition in an amount of no more than 97% by weight, such as no more than 85% by weight, such as no more than 75% by weight, such as no more than 65% by weight, based on the total weight of the powder coating composition. The binder may be present in an amount of 10% to 97% by weight, such as 10% to 85% by weight, such as 10% to 75% by weight, such as 10% to 65% by weight, such as 20% to 97% by weight, such as 20% to 85% by weight, such as 20% to 75% by weight, such as 20% to 65% by weight, such as 40% to 97% by weight, such as 40% to 85% by weight, such as 40% to 75% by weight, such as 40% to 65% by weight, 50% to 97% by weight, such as 50% to 85% by weight, such as 50% to 75% by weight, such as 50% to 65% by weight, 60% to 97% by weight, such as 60% to 85% by weight, such as 60% to 75% by weight, such as 60% to 65% by weight, based on the total weight of the powder coating composition.

The binder may be present in the powder coating composition in an amount of at least 15% by volume, such as at least 30% by volume, such as at least 50% by volume, based on the total volume of the powder coating composition. The binder may be present in the powder coating composition in an amount of no more than 96% by volume, such as no more than 70% by volume, such as no more than 55% by volume, based on the total volume of the powder coating composition. The binder may be present in an amount of 15% to 96% by volume, such as 25% to 80% by volume, such as 35% to 60% by volume, based on the total volume of the powder coating composition.

According to the present invention, the powder coating composition comprises a thermally conductive, electrically insulative filler material. As used herein, the term “thermally conductive, electrically insulative filler” or “TC/EI filler” means a pigment, filler, or inorganic powder that has a thermal conductivity of at least 5 W/m·K at 25° C. (measured according to ASTM D7984) and a volume resistivity of at least 10 Ω·m (measured according to ASTM D257, C611, or B193). The TC/EI filler material may comprise organic or inorganic material and may comprise particles of a single type of filler material or may comprise particles of two or more types of TC/EI filler materials. That is, the TC/EI filler material may comprise particles of a first TC/EI filler material and may further comprise particles of at least a second (i.e., a second, a third, a fourth, etc.) TC/EI filler material that is different from the first TC/EI filler material. As used herein with respect to types of filler material, reference to “first,” “second”, etc. is for convenience only and does not refer to order of addition or the like.

The TC/EI filler material may have a thermal conductivity of at least 5 W/m·K at 25° C. (measured according to ASTM D7984), such as at least 18 W/m·K, such as at least 55 W/m·K. The TC/EI filler material may have a thermal conductivity of no more than 3,000 W/m·K at 25° C. (measured according to ASTM D7984), such as no more than 1,400 W/m·K, such as no more than 450 W/m·K. The TC/EI filler material may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K.

The TC/EI filler material may have a volume resistivity of at least 10 Ω·m (measured according to ASTM D257, C611, or B193), such as at least 20 Ω·m, such as at least 30 Ω·m, such as at least 40 Ω·m, such as at least 50 Ω·m, such as at least 60 Ω·m, such as at least 60 Ω·m, such as at least 70 Ω·m, such as at least 80 Ω·m, such as at least 80 Ω·m, such as at least 90 Ω·m, such as at least 100 Ω·m.

Suitable non-limiting examples of TC/EI filler materials include nitrides, metal oxides, metalloid oxides, metal hydroxides, arsenides, carbides, minerals, ceramics, and diamond. For example, the TC/EI filler material may comprise, consist essentially of, or consist of boron nitride, silicon nitride, aluminum nitride, boron arsenide, aluminum oxide, magnesium oxide, dead burned magnesium oxide, beryllium oxide, silicon dioxide, titanium oxide, zinc oxide, nickel oxide, copper oxide, tin oxide, aluminum hydroxide (i.e., aluminum trihydrate), magnesium hydroxide, boron arsenide, silicon carbide, agate, emery, ceramic microspheres, diamond, or any combination thereof. Non-limiting examples of commercially available TC/EI filler materials of boron nitride include, for example, CarboTherm from Saint-Gobain, CoolFlow and PolarTherm from Momentive, and as hexagonal boron nitride powder available from Panadyne; of aluminum nitride, for example, aluminum nitride powder available from Micron Metals Inc., and as Toyalnite from Toyal; of aluminum oxide include, for example, Microgrit from Micro Abrasives, Nabalox from Nabaltec, Aeroxide from Evonik, and as Alodur from Imerys; of dead burned magnesium oxide include, for example, MagChem® P98 from Martin Marietta Magnesia Specialties; of aluminum hydroxide include, for example, APYRAL from Nabaltec GmbH and aluminum hydroxide from Sibelco; and of ceramic microspheres include, for example, ceramic microspheres from Zeeospheres Ceramics or 3M. These fillers can also be surface modified. For example, surface modified magnesium oxide available as PYROKISUMA 5301K available from Kyowa Chemical Industry Co., Ltd. Alternatively, the TC/EI filler materials may be free of any surface modification.

As used herein, the term “dead burned magnesium oxide” refers to magnesium oxide that has been calcined at high-temperatures (e.g., ranging from 1500° C.-2000° C. in a high temperature shaft kiln) yielding a material with very little reactivity relative to magnesium oxide that has not been calcined.

The TC/EI filler material may have any particle shape or geometry. For example, the TC/EI filler material may be a regular or irregular shape and may be spherical, ellipsoidal, cubical, platy, acicular (elongated or fibrous), rod-shaped, disk-shaped, prism-shaped, flake-shaped, rock-like, etc., agglomerates thereof, and any combination thereof.

Particles of TC/EI filler material may have a reported average particle size in at least one dimension of at least 0.01 microns, as reported by the manufacturer, such as at least 2 microns, such as at least 10 microns. Particles of TC/EI filler material may have a reported average particle size in at least one dimension of no more than 500 microns as reported by the manufacturer, such as no more than 300 microns, such as no more than 200 microns, such as no more than 150 microns. The particles of TC/EI filler material may have a reported average particle size in at least one dimension of 0.01 microns to 500 microns as reported by the manufacturer, such as 0.1 microns to 300 microns, such as 2 microns to 200 microns, such as 10 microns to 150 microns. Suitable methods of measuring average particle size include measurement using an instrument such as the Quanta 250 FEG SEM or an equivalent instrument.

Particles of TC/EI filler material of the powder coating composition may have a reported Mohs hardness of at least 1 (based on the Mohs Hardness Scale), such as at least 2, such as at least 3. Particles of TC/EI filler material of the powder coating composition may have a reported Mohs hardness of no more than 10, such as no more than 8, such as no more than 7. Particles of TC/EI filler material of the powder coating composition may have a reported Mohs hardness of 1 to 10, such as 2 to 8, such as 3 to 7.

The TC/EI filler material may be included as a single TC/EI filler material or may be included as a combination of two or more of the TC/EI filler materials described above. For example, the thermally conductive, electrically insulative filler materials comprise, consist essentially of, or consist of at least two of aluminum hydroxide, dead burned magnesium oxide, and boron nitride. For example, the thermally conductive, electrically insulative filler materials comprise, consist essentially of, or consist of aluminum hydroxide and dead burned magnesium oxide. For example, the thermally conductive, electrically insulative filler materials comprise, consist essentially of, or consist of aluminum hydroxide and boron nitride. If more than two TC/EI filler materials are used, the weight ratio between the two TC/EI filler materials may be at least 1:30, such as at least 1:25, such as at least 1:20, such as at least 1:15, such as at least 1:10, such as at least 1:8, such as at least 1:7, such as at least 1:5, such as at least 1:4, such as at least 1:3, such as at least 1:2.5, such as at least 1:2, such as 1:1.5, such as at least 1:1.4, such as at least 1:1.2, such as 1:1, based on the total combined weight of the TC/EI filler material. If more than two TC/EI filler materials are used, the weight ratio between the two TC/EI filler materials may be 1:30 to 30:1, such as 1:25 to 25:1, such as 1:20 to 20:1, such as 1:15 to 15:1, such as 1:10 to 10:1, such as 1:8 to 8:1, such as 1:7 to 7:1, such as 1:5 to 5:1, such as 1:3 to 3:1, such as 1:2 to 2:1, such as 1:1.5 to 1.5:1, such as 1:1.4 to 1.4:1, such as 1:1.2 to 1.2:1, such as 1:2 to 1.4:1, such as 1:2 to 1.5:1, based on the total combined weight of the TC/EI filler material.

For example, the thermally conductive, electrically insulative filler materials comprise, consist essentially of, or consist of aluminum hydroxide in an amount of 1% to 80% by weight, such as 10% to 60% by weight, such as 15% to 50% by weight, such as 20% to 40% by weight, such as 25% to 35% by weight, such as 27% to 33% by weight, and dead burned magnesium oxide in an amount of 1% to 80% by weight, such as 5% to 60% by weight, such as 7% to 50% by weight, such as 10% to 40% by weight, such as 12% to 35% by weight, such as 15% to 30% by weight, such as 17% to 25% by weight, such as 18% to 22% by weight, based on the total weight of the powder coating composition.

For example, the thermally conductive, electrically insulative filler materials comprise, consist essentially of, or consist of aluminum hydroxide in an amount of 1% to 80% by weight, such as 10% to 60% by weight, such as 15% to 50% by weight, such as 20% to 40% by weight, such as 25% to 35% by weight, such as 27% to 33% by weight, and boron nitride in an amount of 1% to 80% by weight, such as 5% to 60% by weight, such as 7% to 50% by weight, such as 10% to 40% by weight, such as 12% to 35% by weight, such as 15% to 30% by weight, such as 17% to 25% by weight, such as 18% to 22% by weight, based on the total weight of the powder coating composition.

For example, the thermally conductive, electrically insulative filler material of the powder coating composition may comprise, consist essentially of, or consist of aluminum hydroxide in an amount of at least 1% by weight, such as at least 5% by weight, such as at least 10% by weight, such as at least 20% by weight, such as at least 25% by weight, such as at least 30% by weight, such as at least 35% by weight, such as at least 40% by weight, such as at least 45% by weight, such as at least 50% by weight, such as at least 55% by weight, such as at least 60% by weight, such as at least 65% by weight, such as at least 70% by weight, such as at least 75% by weight, based on the total weight of the powder coating composition. The thermally conductive, electrically insulative filler material of the powder coating composition may comprise, consist essentially of, or consist of aluminum hydroxide in an amount of no more than 80% by weight, such as no more than 75% by weight, such as no more than 70% by weight, such as no more than 65% by weight, such as no more than 60% by weight, such as no more than 55% by weight, such as no more than 50% by weight, such as no more than 45% by weight, such as no more than 40% by weight, such as no more than 35% by weight, such as no more than 30% by weight, such as no more than 25% by weight, such as no more than 20% by weight, such as no more than 15% by weight, such as no more than 10% by weight, such as no more than 5% by weight, based on the total weight of the powder coating composition. The thermally conductive, electrically insulative filler material of the powder coating composition may comprise, consist essentially of, or consist of aluminum hydroxide in an amount of 1% to 80% by weight, such as 5% to 80% by weight, such as 10% to 80% by weight, such as 15% to 80% by weight, such as 20% to 80% by weight, such as 25% to 80% by weight, such as 30% to 80% by weight, such as 35% to 80% by weight, such as 40% to 80% by weight, such as 45% to 80% by weight, such as 50% to 80% by weight, such as 55% to 80% by weight, such as 60% to 80% by weight, such as 65% to 80% by weight, such as 70% to 80% by weight, such as 75% to 80% by weight, such as 1% to 70% by weight, such as 5% to 70% by weight, such as 10% to 70% by weight, such as 15% to 70% by weight, such as 20% to 70% by weight, such as 25% to 70% by weight, such as 30% to 70% by weight, such as 35% to 70% by weight, such as 40% to 70% by weight, such as 45% to 70% by weight, such as 50% to 70% by weight, such as 55% to 70% by weight, such as 60% to 70% by weight, such as 65% to 70% by weight, such as 1% to 65% by weight, such as 5% to 65% by weight, such as 10% to 65% by weight, such as 15% to 65% by weight, such as 20% to 65% by weight, such as 25% to 65% by weight, such as 30% to 65% by weight, such as 35% to 65% by weight, such as 40% to 65% by weight, such as 45% to 65% by weight, such as 50% to 65% by weight, such as 55% to 65% by weight, such as 1% to 60% by weight, such as 5% to 60% by weight, such as 10% to 60% by weight, such as 15% to 60% by weight, such as 20% to 60% by weight, such as 25% to 60% by weight, such as 25% to 60% by weight, such as 30% to 60% by weight, such as 35% to 60% by weight, such as 40% to 60% by weight, such as 45% to 60% by weight, such as 50% to 60% by weight, such as 55% to 60% by weight, such as 1% to 55% by weight, such as 5% to 55% by weight, such as 10% to 55% by weight, such as 15% to 55% by weight, such as 20% to 55% by weight, such as 25% to 55% by weight, such as 30% to 55% by weight, such as 35% to 55% by weight, such as 40% to 55% by weight, such as 45% to 55% by weight, such as 1% to 50% by weight, such as 5% to 50% by weight, such as 10% to 50% by weight, such as 15% to 50% by weight, such as 20% to 50% by weight, such as 25% to 50% by weight, such as 30% to 50% by weight, such as 35% to 50% by weight, such as 40% to 50% by weight, such as 45% to 50% by weight, such as 1% to 45% by weight, such as 5% to 45% by weight, such as 10% to 45% by weight, such as 15% to 45% by weight, such as 20% to 45% by weight, such as 25% to 45% by weight, such as 30% to 45% by weight, such as 35% to 45% by weight, such as 40% to 45% by weight, such as 1% to 40% by weight, such as 5% to 40% by weight, such as 10% to 40% by weight, such as 15% to 40% by weight, such as 20% to 40% by weight, such as 25% to 40% by weight, such as 30% to 40% by weight, such as 35% to 40% by weight, such as 1% to 35% by weight, such as 5% to 35% by weight, such as 10% to 35% by weight, such as 15% to 35% by weight, such as 20% to 35% by weight, such as 25% to 35% by weight, such as 30% to 35% by weight, such as 1% to 25% by weight, such as 5% to 25% by weight, such as 10% to 25% by weight, such as 15% to 25% by weight, such as 20% to 25% by weight, such as 1% to 20% by weight, such as 5% to 20% by weight, such as 10% to 20% by weight, such as 15% to 20% by weight, such as 1% to 15% by weight, such as 5% to 15% by weight, such as 10% to 15% by weight, such as 1% to 10% by weight, such as 5% to 10% by weight, based on the total weight of the powder coating composition.

The thermally conductive, electrically insulative filler material of the powder coating composition may be present in an amount of at least 1% by weight, such as at least 5% by weight, such as at least 10% by weight, such as at least 20% by weight, such as at least 25% by weight, such as at least 30% by weight, such as at least 35% by weight, such as at least 40% by weight, such as at least 45% by weight, such as at least 50% by weight, such as at least 55% by weight, such as at least 60% by weight, such as at least 65% by weight, such as at least 70% by weight, such as at least 75% by weight, based on the total weight of the powder coating composition. The thermally conductive, electrically insulative filler material of the powder coating composition may be present in an amount of no more than 80% by weight, such as no more than 75% by weight, such as no more than 70% by weight, such as no more than 65% by weight, such as no more than 60% by weight, such as no more than 55% by weight, such as no more than 50% by weight, such as no more than 45% by weight, such as no more than 40% by weight, such as no more than 35% by weight, such as no more than 30% by weight, such as no more than 25% by weight, such as no more than 20% by weight, such as no more than 15% by weight, such as no more than 10% by weight, such as no more than 5% by weight, based on the total weight of the powder coating composition. The thermally conductive, electrically insulative filler material of the powder coating composition may be present in an amount of 1% to 80% by weight, such as 5% to 80% by weight, such as 10% to 80% by weight, such as 15% to 80% by weight, such as 20% to 80% by weight, such as 25% to 80% by weight, such as 30% to 80% by weight, such as 35% to 80% by weight, such as 40% to 80% by weight, such as 45% to 80% by weight, such as 50% to 80% by weight, such as 55% to 80% by weight, such as 60% to 80% by weight, such as 65% to 80% by weight, such as 70% to 80% by weight, such as 75% to 80% by weight, such as 1% to 70% by weight, such as 5% to 70% by weight, such as 10% to 70% by weight, such as 15% to 70% by weight, such as 20% to 70% by weight, such as 25% to 70% by weight, such as 30% to 70% by weight, such as 35% to 70% by weight, such as 40% to 70% by weight, such as 45% to 70% by weight, such as 50% to 70% by weight, such as 55% to 70% by weight, such as 60% to 70% by weight, such as 65% to 70% by weight, such as 1% to 65% by weight, such as 5% to 65% by weight, such as 10% to 65% by weight, such as 15% to 65% by weight, such as 20% to 65% by weight, such as 25% to 65% by weight, such as 30% to 65% by weight, such as 35% to 65% by weight, such as 40% to 65% by weight, such as 45% to 65% by weight, such as 50% to 65% by weight, such as 55% to 65% by weight, such as 1% to 60% by weight, such as 5% to 60% by weight, such as 10% to 60% by weight, such as 15% to 60% by weight, such as 20% to 60% by weight, such as 25% to 60% by weight, such as 25% to 60% by weight, such as 30% to 60% by weight, such as 35% to 60% by weight, such as 40% to 60% by weight, such as 45% to 60% by weight, such as 50% to 60% by weight, such as 55% to 60% by weight, such as 1% to 55% by weight, such as 5% to 55% by weight, such as 10% to 55% by weight, such as 15% to 55% by weight, such as 20% to 55% by weight, such as 25% to 55% by weight, such as 30% to 55% by weight, such as 35% to 55% by weight, such as 40% to 55% by weight, such as 45% to 55% by weight, such as 1% to 50% by weight, such as 5% to 50% by weight, such as 10% to 50% by weight, such as 15% to 50% by weight, such as 20% to 50% by weight, such as 25% to 50% by weight, such as 30% to 50% by weight, such as 35% to 50% by weight, such as 40% to 50% by weight, such as 45% to 50% by weight, such as 1% to 45% by weight, such as 5% to 45% by weight, such as 10% to 45% by weight, such as 15% to 45% by weight, such as 20% to 45% by weight, such as 25% to 45% by weight, such as 30% to 45% by weight, such as 35% to 45% by weight, such as 40% to 45% by weight, such as 1% to 40% by weight, such as 5% to 40% by weight, such as 10% to 40% by weight, such as 15% to 40% by weight, such as 20% to 40% by weight, such as 25% to 40% by weight, such as 30% to 40% by weight, such as 35% to 40% by weight, such as 1% to 35% by weight, such as 5% to 35% by weight, such as 10% to 35% by weight, such as 15% to 35% by weight, such as 20% to 35% by weight, such as 25% to 35% by weight, such as 30% to 35% by weight, such as 1% to 25% by weight, such as 5% to 25% by weight, such as 10% to 25% by weight, such as 15% to 25% by weight, such as 20% to 25% by weight, such as 1% to 20% by weight, such as 5% to 20% by weight, such as 10% to 20% by weight, such as 15% to 20% by weight, such as 1% to 15% by weight, such as 5% to 15% by weight, such as 10% to 15% by weight, such as 1% to 10% by weight, such as 5% to 10% by weight, based on the total weight of the powder coating composition.

The thermally conductive, electrically insulative filler material may be present in an amount of at least 1% by volume, such as at least 5% by volume, such as at least 25% by volume, such as at least 30% by volume, based on the total volume of the powder coating composition. The thermally conductive, electrically insulative filler material may be present in an amount of no more than 70% by volume, such as no more than 50% by volume, such as no more than 30% by volume, based on the total volume of the powder coating composition. The thermally conductive, electrically insulative filler material may be present in an amount of 1% to 70% by volume, such as 5% to 50% by volume, such as 25% to 50% by volume, such as 30% to 50% by volume, based on the total volume of the powder coating composition.

According to the present invention, the powder coating composition and binder may optionally comprise a thermoplastic material. As used herein, the term “thermoplastic material” refers to a compound that has a higher molecular weight than the film-forming resin and crosslinker (if present) of the powder coating composition. The thermoplastic material optionally may be free of functional groups that react with the crosslinker of the powder coating composition under normal cure conditions. The thermoplastic material is part of the binder of the powder coating composition and is different than the film-forming resins and crosslinker (if present) of the binder of thermoset and thermoplastic powder coating compositions described above. The thermoplastic material may comprise a phenoxy resin (a polyhydroxyether resin).

The thermoplastic material may have a melt temperature (Tm) of at least 50° C., such as at least 60° C., such as at least 70° C., such as at least 80° C., such as at least 90° C., such as at least 100° C., such as at least 110° C., such as at least 120° C., such as at least 130° C., such as at least 140° C., such as at least 150° C., such as at least 160° C., such as 120° C.

The thermoplastic material may have a glass transition temperature (Tg) of at least −30° C., such as at least −20° C., such as at least −10° C., such as at least 0° C., such as at least 10° C., such as at least 20° C., such as at least 30° C., such as at least 40° C., such as at least 50° C., such as at least 60° C., such as at least 70° C., such as at least 75° C., such as at least 80° C., such as at least 84° C., such as 84° C.

The thermoplastic material may have a melt index at 200° C. of at least at least 40 g/10 min., such as at least 45 g/10 min., such as at least 50 g/10 min., such as at least 55 g/10 min., such as at least 60 g/10 min., such as 60 g/10 min.

The thermoplastic material may have a melt viscosity at 200° C. of at least 90 Poise, such as at least 95 Poise, such as at least 100 Poise, such as at least 105 Poise, such as at least 110 Poise, such as at least 112 Poise, such as 112 Poise.

The thermoplastic material in a 20% by weight solution in cyclohexanone may have a viscosity range of 180-300 cP, such as 180-280 cP, as measured using a Brookfield viscometer at 25° C.

The thermoplastic material may have a weight average molecular weight of at least 10,000 g/mol, such as at least 15,000 g/mol, such as at least 20,000 g/mol, such as at least 25,000 g/mol, such as at least 30,000 g/mol. The thermoplastic material may have a weight average molecular weight of no more than 1,000,000 g/mol, such as no more than 500,000 g/mol, such as no more than 100,000 g/mol, such as no more than 50,000 g/mol, such as no more than 40,000 g/mol, such as no more than 35,000 g/mol. The thermoplastic material may have a weight average molecular weight of 10,000 to 1,000,000 g/mol, such as 15,000 to 500,000 g/mol, such as 15,000 to 100,000 g/mol, such as 15,000 to 50,000 g/mol, such as 15,000 to 40,000 g/mol, such as 15,000 to 35,000 g/mol, such as 20,000 to 1,000,000 g/mol, such as 20,000 to 500,000 g/mol, such as 20,000 to 100,000 g/mol, such as 20,000 to 50,000 g/mol, such as 20,000 to 40,000 g/mol, such as 20,000 to 35,000 g/mol, 25,000 to 1,000,000 g/mol, such as 25,000 to 500,000 g/mol, such as 25,000 to 100,000 g/mol, such as 25,000 to 50,000 g/mol, such as 25,000 to 40,000 g/mol, such as 25,000 to 35,000 g/mol, 30,000 to 1,000,000 g/mol, such as 30,000 to 500,000 g/mol, such as 30,000 to 100,000 g/mol, such as 30,000 to 50,000 g/mol, such as 30,000 to 40,000 g/mol, such as 30,000 to 35,000 g/mol, such as 32,000 g/mol.

The thermoplastic material may have a number average molecular weight of at least 5,000 g/mol, such as at least 8,000 g/mol, such as at least 9,000 g/mol. The thermoplastic material may have a number average molecular weight of no more than 100,000 g/mol, such as no more than 50,000 g/mol, such as no more than 25,000 g/mol, such as no more than 15,000 g/mol, such as no more than 10,000 g/mol. The thermoplastic material may have a number average molecular weight of 5,000 to 100,000 g/mol, 5,000 to 50,000 g/mol, 5,000 to 25,000 g/mol, 5,000 to 15,000 g/mol, 5,000 to 10,000 g/mol, such as 8,000 to 100,000 g/mol, 8,000 to 50,000 g/mol, such as 8,000 to 25,000 g/mol, such as 8,000 to 15,000 g/mol, such as 8,000 to 10,000 g/mol, such as 9,000 to 100,000 g/mol, 9,000 to 50,000 g/mol, such as 9,000 to 25,000 g/mol, such as 9,000 to 15,000 g/mol, such as 9,000 to 10,000 g/mol, such as 9,500 g/mol.

Weight average molecular weight (Mw) and number average molecular weight (M) may be measured by gel permeation chromatography using a polystyrene standard according to ASTM D6579-11. The gel permeation chromatography relative to linear polystyrene standards of 800 to 900,000 Da may be performed using a Waters 2695 separation module with a Waters 2414 differential refractometer (RI detector), tetrahydrofuran (THF) as the eluent at a flow rate of 1 ml/min, and with two PLgel Mixed-C (300×7.5 mm) columns for separation performed at room temperature.

The thermoplastic material may optionally comprise functional groups. For example, the thermoplastic material may comprise hydroxyl functional groups. A thermoplastic material comprising hydroxyl functional groups may have a hydroxyl equivalent weight of at least 200 g/equivalent, such as at least 240 g/equivalent, such as at least 250 g/equivalent, such as at least 260 g/equivalent, such as at least 270 g/equivalent. A thermoplastic material comprising hydroxyl functional groups may have a hydroxyl equivalent weight of no more than 500,000 g/equivalent, such as no more than 250,000 g/equivalent, such as no more than 100,000 g/equivalent, such as no more than 50,000 g/equivalent, such as no more than 25,000 g/equivalent, such as no more than 10,000 g/equivalent, such as no more than 1,000 g/equivalent, such as no more than 500 g/equivalent, such as no more than 350 g/equivalent, such as no more than 300 g/equivalent, such as no more than 285 g/equivalent. A thermoplastic material comprising hydroxyl functional groups may have a hydroxyl equivalent weight of such as 200 to 500,000 g/equivalent, such as 200 to 250,000 g/equivalent, such as 200 to 100,000 g/equivalent, such as 200 to 50,000 g/equivalent, such as 200 to 25,000 g/equivalent, such as 200 to 10,000 g/equivalent, such as 200 to 1,000 g/equivalent, such as 200 to 500 g/equivalent, such as 200 to 350 g/equivalent, such as 240 to 350 g/equivalent, such as 250 to 350 g/equivalent, such as 260 to 300 g/equivalent, such as 260 to 300 g/equivalent, such as 200 to 300 g/equivalent, such as 240 to 300 g/equivalent, such as 250 to 300 g/equivalent, such as 260 to 300 g/equivalent, such as 260 to 300 g/equivalent, such as 200 to 285 g/equivalent, such as 240 to 285 g/equivalent, such as 250 to 285 g/equivalent, such as 260 to 285 g/equivalent, such as 260 to 285 g/equivalent, such as 277 g/equivalent.

The thermoplastic material may be present in the powder coating composition, if at all, in an amount of at least 0.5% by weight, such as at least 1% by weight, such as at least 3% by weight, such as at least 6% by weight, such as at least 7% by weight, based on the total weight of the powder coating composition. The thermoplastic material may be present in the powder coating composition, if at all, in an amount of no more than 20%, such as no more than 10% by weight, such as no more than 9% by weight, such as no more than 8.5% by weight, based on the total weight of the powder coating composition. The thermoplastic material may be present in an amount of 0.5% to 20% by weight, such as 0.5% to 10% by weight, such as 0.5% to 9% by weight, such as 0.5% to 8.5% by weight, such as 1% to 20% by weight, such as 1% to 10% by weight, such as 1% to 9% by weight, such as 1% to 8.5% by weight, such as 3% to 20% by weight, such as 3% to 10% by weight, such as 3% to 9% by weight, such as 3% to 8.5% by weight, such as 6% to 20% by weight, such as 6% to 10% by weight, such as 6% to 9% by weight, such as 6% to 8.5% by weight, such as 7% to 20% by weight, such as 7% to 10% by weight, such as 7% to 9% by weight, such as 7% to 8.5% by weight, based on the total weight of the powder coating composition.

The thermoplastic material may be present in the powder coating composition, if at all, in an amount of at least 1% by volume, such as at least 4% by volume, such as at least 7% by volume, based on the total volume of the powder coating composition. The thermoplastic material may be present in the powder coating composition, if at all, in an amount of no more than 30% by volume, such as no more than 15% by volume, such as no more than 8% by volume, based on the total volume of the powder coating composition. The thermoplastic material may be present in an amount of 1% to 30% by volume, such as 4% to 15% by volume, such as 6% to 10% by volume, based on the total volume of the powder coating composition.

According to the present invention, the powder coating composition may optionally comprise particles of thermally conductive, electrically conductive filler material (referred to herein as “TC/EC” filler material) and/or particles of non-thermally conductive, electrically insulative filler material (referred to herein as “NTC/EI” filler material). The TC/EC filler material and/or the NTC/EI filler material may be organic or inorganic.

The TC/EC filler material and/or NTC/EI filler material may have any particle shape or geometry. For example, the TC/EC filler material and/or the NTC/EI filler material may be a regular or irregular shape and may be spherical, ellipsoidal, cubical, platy, acicular (elongated or fibrous), rod-shaped, disk-shaped, prism-shaped, flake-shaped, rock-like, etc., agglomerates thereof, and any combination thereof.

Particles of the TC/EC filler material and/or the NTC/EI filler material may have a reported average particle size in at least one dimension of at least 0.01 microns, as reported by the manufacturer, such as at least 2 microns, such as at least 10 microns. Particles of the TC/EC filler material and/or the NTC/EI filler material may have a reported average particle size in at least one dimension of no more than 500 microns as reported by the manufacturer, such as no more than 300 microns, such as no more than 200 microns, such as no more than 150 microns. Particles of the TC/EC filler material and/or the NTC/EI filler material may have a reported average particle size in at least one dimension of 0.01 microns to 500 microns as reported by the manufacturer, such as 0.1 microns to 300 microns, such as 2 microns to 200 microns, such as 10 microns to 150 microns. Suitable methods of measuring average particle size include measurement using an instrument such as the Quanta 250 FEG SEM or an equivalent instrument.

Particles of TC/EC filler material and/or the NTC/EI filler material of the powder coating composition may have a reported Mohs hardness of at least 1 (based on the Mohs Hardness Scale), such as at least 2, such as at least 3. Particles of TC/EC filler material and/or the NTC/EI filler material of the powder coating composition may have a reported Mohs hardness of no more than 10, such as no more than 8, such as no more than 7. Particles of TC/EC filler material and/or the NTC/EI filler material of the powder coating composition may have a reported Mohs hardness of 1 to 10, such as 2 to 8, such as 3 to 7.

As used herein, the term “thermally conductive, electrically conductive filler” or “TC/EC filler” means a pigment, filler, or inorganic powder that has a thermal conductivity of at least 5 W/m·K at 25° C. (measured according to ASTM D7984) and a volume resistivity of less than 10 Ω·m (measured according to ASTM D257, C611, or B193). For example, the TC/EC filler material may have a thermal conductivity of at least 5 W/m·K at 25° C. (measured according to ASTM D7984), such as at least 18 W/m·K, such as at least 55 W/m·K. The TC/EC filler material may have a thermal conductivity of no more than 3,000 W/m·K at 25° C. (measured according to ASTM D7984), such as no more than 1,400 W/m·K, such as no more than 450 W/m·K. The TC/EC filler material may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K. For example, the TC/EC filler material may have a volume resistivity of less than 10 Ω·m (measured according to ASTM D257, C611, or B193), such as less than 5 Ω·m, such as less than 1 Ω·m.

Suitable TC/EC filler materials include metals such as silver, zinc, copper, gold, or metal coated hollow particles. carbon compounds such as, graphite (such as Timrex commercially available from Imerys or ThermoCarb commercially available from Asbury Carbons), carbon black (for example, commercially available as Vulcan from Cabot Corporation), carbon fibers (for example, commercially available as milled carbon fiber from Zoltek), graphene and graphenic carbon particles (for example, xGnP graphene nanoplatelets commercially available from XG Sciences, and/or for example, the graphene particles described below), carbonyl iron, copper (such as spheroidal powder commercially available from Sigma Aldrich), zinc (such as Ultrapure commercially available from Purity Zinc Metals and Zinc Dust XL and XLP available from US Zinc), and the like.

Examples of “graphenic carbon particles” include carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which is incorporated herein by reference. Other suitable graphenic carbon particles are described in U.S. Pat. No. 9,562,175, at 6:6 to 9:52, the cited portion of which are incorporated herein by reference.

The TC/EC filler materials may be present in the powder coating composition, if at all, in an amount of at least 1% by weight, such as at least 2% by weight, such as at least 3% by weight, such as at least 4% by weight, based on the total weight of the powder coating composition. The TC/EC filler materials may be present in the powder coating composition, if at all, in an amount of no more than 35% by weight, such as no more than 20% by weight, such as no more than 10% by weight, such as no more than 8% by weight, based on the total weight of the powder coating composition. The TC/EC filler materials may be present in an amount of 1% to 35% by weight, such as 2% to 20% by weight, such as 3% to 10% by weight, such as 4% to 8% by weight, based on the total weight of the powder coating composition.

The TC/EC filler materials may be present in the powder coating composition, if at all, in an amount of at least 1% by volume, such as at least 5% by volume, such as at least 10% by volume, such as at least 20% by volume, based on the total volume of the powder coating composition. The TC/EC filler materials may be present in the powder coating composition, if at all, in an amount of no more than 30% by volume, such as no more than 25% by volume, such as no more than 20% by volume, such as no more than 15% by volume, based on the total volume of the powder coating composition. The TC/EC filler materials may be present in an amount of 1% to 30% by volume, such as 1% to 25% by volume, such as 5% to 20% by volume, such as 10% to 15% by volume, based on the total volume of the powder coating composition.

As used herein, the term “non-thermally conductive, electrically insulative filler” or “NTC/EI filler” means a pigment, filler, or inorganic powder that that has a thermal conductivity of less than 5 W/m·K at 25° C. (measured according to ASTM D7984) and a volume resistivity of at least 10 Ω·m (measured according to ASTM D257, C611, or B193). For example, the NTC/EI filler may have a thermal conductivity of less than 5 W/m·K at 25° C. (measured according to ASTM D7984, such no more than 3 W/m·K, such as no more than 1 W/m·K, such as no more than 0.1 W/m·K, such as no more than 0.05 W/m·K. For example, the NTC/EI filler may have a volume resistivity of at least 10 Ω·m (measured according to ASTM D257, C611, or B193), such as at least 20 Ω·m, such as at least 30 Ω·m, such as at least 40 Ω·m, such as at least 50 Ω·m, such as at least 60 Ω·m, such as at least 60 Ω·m, such as at least 70 Ω·m, such as at least 80 Ω·m, such as at least 80 Ω·m, such as at least 90 Ω·m, such as at least 100 Ω·m.

Suitable non-limiting examples of NTC/EI filler materials include but are not limited to mica, silica, wollastonite, calcium carbonate, barium sulfate, glass microspheres, clay, or any combination thereof.

As used herein, the term “mica” generally refers to sheet silicate (phyllosilicate) minerals. The mica may comprise muscovite mica. Muscovite mica comprises a phyllosilicate mineral of aluminum and potassium with the formula KAl₂(AlSi₃O₁₀)(F,OH)₂ or (KF)₂(Al₂O₃)₃(SiO₂)₆(H₂O). Exemplary non-limiting commercially available muscovite mica include products sold under the trade name DakotaPURE™, such as DakotaPURE™ 700, DakotaPURE™ 1500, DakotaPURE™ 2400, DakotaPURE™ 3000, DakotaPURE™ 3500 and DakotaPURE™ 4000, available from Pacer Minerals.

The silica (SiO₂) may comprise fumed silica which comprises silica that has been treated with a flame to form a three-dimensional structure. The fumed silica may be untreated or surface treated with a siloxane, such as, for example, polydimethylsiloxane. Exemplary non-limiting commercially available fumed silica includes products solder under the trade name AEROSIL®, such as AEROSIL® R 104, AEROSIL® R 106, AEROSIL® R 202, AEROSIL® R 208, AEROSIL® R 972 commercially available from Evonik Industries and products sold under the trade name HDK® such as HDK® H17 and HDK® H18 commercially available from Wacker Chemie AG.

Wollastonite comprises a calcium inosilicate mineral (CaSiO₃) that may contain small amounts of iron, aluminum, magnesium, manganese, titanium and/or potassium. For example, the wollastonite may have a B.E.T. surface area of 1.5 to 2.1 m²/g, such as 1.8 m²/g and a median particle size of 6 microns to 10 microns, such as 8 microns. Non-limiting examples of commercially available wollastonite include NYAD 400 available from NYCO Minerals, Inc.

The calcium carbonate (CaCO₃) may comprise a precipitated calcium carbonate or a ground calcium carbonate. The calcium carbonate may or may not be surface treated with stearic acid. Non-limiting examples of commercially available precipitated calcium carbonate include Ultra-Pflex®, Albafil®, and Albacar HO® available from Specialty Minerals and Winnofil® SPT available from Solvay. Non-limiting examples of commercially available ground calcium carbonate include Duramite™ available from IMERYS and Marblewhite® available from Specialty Minerals.

Useful clay minerals include a non-ionic platy filler such as talc, pyrophyllite, chlorite, vermiculite, or combinations thereof.

The glass microspheres may be hollow borosilicate glass. Non-limiting examples of commercially available glass microspheres include 3M Glass bubbles type VS, K series, and S series available from 3M.

The NTC/EI filler materials may be present in the powder coating composition, if at all, in an amount of at least 0.5% by weight, such as at least 1% by weight, such as at least 2% by weight, such as at least 3% by weight, such as at least 4% by weight, based on the total weight of the powder coating composition. The NTC/EI filler materials may be present in the powder coating composition, if at all, in an amount of no more than 40% by weight, such as no more than 35% by weight, such as no more than 20% by weight, such as no more than 10% by weight, such as no more than 8% by weight, based on the total weight of the powder coating composition. The NTC/EI filler materials may be present in an amount of 0.5% to 40% by weight, such as 1% to 35% by weight, such as 2% to 20% by weight, such as 3% to 10% by weight, such as 4% to 8% by weight, based on the total weight of the powder coating composition.

The NTC/EI filler materials may be present in the powder coating composition, if at all, in an amount of at least 1% by volume, such as at least 10% by volume, such as at least 20% by volume, based on the total volume of the powder coating composition. The NTC/EI filler materials may be present in the powder coating composition, if at all, in an amount of no more than 60% by volume, such as no more than 40% by volume, such as no more than 30% by volume, based on the total volume of the powder coating composition. The NTC/EI filler materials may be present in an amount of 1% to 60% by volume, such as 5% to 40% by volume, such as 10% to 30% by volume, based on the total volume of the powder coating composition.

According to the present invention, the powder coating composition optionally may further comprise a dispersant. As used herein, the term “dispersant” refers to a substance that may be added to the composition in order to improve the separation of the filler particles by wetting the particles and breaking apart agglomerates. The dispersant, if present at all, may be present in the composition in an amount of at least 0.05% by volume, based on total volume of the filler, such as at least 0.2% by volume, and may be present in an amount of no more than 20% by volume, based on total volume of the filler, such as no more than 10% by volume, such as no more than 3% by volume, such as no more than 1% by volume. The dispersant, if present at all, may be present in the composition in an amount of 0.05% by volume to 20% by volume, based on total volume of the filler, such as 0.2% by volume to 10% by volume, such as 0.2% by volume to 3% by volume, such as 0.2% by volume to 1% by volume. As used herein, the filler refers to the non-binder additives included in the powder coating composition, such as the thermally conductive, electrically insulative filler material, the non-thermally conductive, electrically insulative filler material, the non-thermally conductive, electrically conductive filler material, and any other colorant or pigments included in the composition. Suitable dispersants for use in the composition include fatty acid, phosphoric acid esters, polyurethanes, polyamines, polyacrylates, polyalkoxylates, sulfonates, polyethers, and polyesters, or any combination thereof. Non-limiting examples of commercially available dispersants include ANTI-TERRA-U100, DISPERBYK-102, DISPERBYK-103, DISPERBYK-111, DISPERBYK-171, DISPERBYK-2151, DISPERBYK-2059, DISPERBYK-2000, DISPERBYK-2117, and DISPERBYK-2118 available from BYK Company; and SOLSPERSE 24000SC, SOLSPERSE 16000 and SOLSPERSE 8000 hyperdispersants available from The Lubrizol Corporation.

According to the present invention, the powder coating composition optionally may further comprise a core-shell polymer. Examples of the core-shell polymer include particles wherein a core composed of an elastomer polymer is covered with a shell layer composed of a glassy polymer, particles wherein a core composed of a glassy polymer is covered with a shell layer composed of an elastomer polymer, and particles having three-layer structures wherein the two-layer structures above are covered with a third outermost layer. Where necessary, the shell layer or the outermost layer may be modified so that functional groups such as carboxyl group, epoxy group and hydroxyl group will be introduced therein to provide compatibility and reactivity with the thermosetting resin. Examples of the cores include polybutadienes, acrylic polymers and polyisoprenes. Examples of the shell layers include alkyl (meth)acrylate copolymers, alkyl (meth)acrylate-styrene copolymers and alkyl (meth)acrylate copolymers. In examples, the core may be composed of a rubber polymer with a glass transition temperature of not more than room temperature such as polybutadiene, and a shell layer is composed of an alkyl (meth)acrylate polymer or copolymer with a glass transition temperature of not less than 60° C.

Examples of the core-shell polymer includes STAPHYLOID IM-101, STAPHYLOID IM-203, STAPHYLOID IM-301, STAPHYLOID IM-401, STAPHYLOID IM-601, STAPHYLOID AC3355, STAPHYLOID AC3816, STAPHYLOID AC3832, STAPHYLOID AC4030, STAPHYLOID AC3364 (manufactured by GANZ CHEMICAL CO., LTD.), KUREHA BTA751, KUREHA BTA731, KUREHA PARALOID EXL2314, KUREHA PARALOID EXL2655 (manufactured by KUREHA CORPORATION), Albidur 2240, Albidur 5340, Albidur 5640 (manufactured by Hanse Chemie), PARALOID EXL2655, PARALOID EXL2605, PARALOID EXL2602, PARALOID EXL2311, PARALOID EXL2313, PARALOID EXL2314, PARALOID EXL2315, PARALOID BTA705, PARALOID BTA712, PARALOID BTA731, PARALOID BTA751, PARALOID KM357P, PARALOID KM336P, PARALOID HIA80 and PARALOID HIA28S (manufactured by Rohm and Hass Company).

The core-shell polymer may have a spherical or substantially spherical shape. As used herein, the words “substantially spherical” mean that the longer diameter/shorter diameter ratio in an arbitrary elliptical cross section is from 1 to 10. The core-shell polymer may have an average particle diameter of 0.01 to 10 μm, such as 0.1 to 5 μm. In the invention, the average particle diameter indicates a biaxial average particle diameter represented by (longer axis+shorter axis)/2. The average particle diameter may be determined by laser diffraction particle size distribution analysis.

The core-shell polymer may be present in the powder coating composition, if at all, in an amount of at least 1% by weight, such as at least 2% by weight, such as at least 3% by weight, such as at least 4% by weight, based on the total weight of the powder coating composition. The core-shell polymer may be present in the powder coating composition, if at all, in an amount of no more than 35% by weight, such as no more than 20% by weight, such as no more than 10% by weight, such as no more than 8% by weight, based on the total weight of the powder coating composition. The core-shell polymer may be present in an amount of 1% to 35% by weight, such as 1% to 20% by weight, such as 1% to 10% by weight, such as 1% to 8% by weight, such as 2% to 35% by weight, such as 2% to 20% by weight, such as 2% to 10% by weight, such as 2% to 8% by weight, such as 3% to 35% by weight, such as 3% to 20% by weight, such as 3% to 10% by weight, such as 3% to 8% by weight, such as 4% to 35% by weight, such as 4% to 20% by weight, such as 4% to 10% by weight, such as 4% to 8% by weight, based on the total weight of the powder coating composition.

The core-shell polymer may be present in the powder coating composition, if at all, in an amount of at least 1% by volume, such as at least 5% by volume, such as at least 10% by volume, such as at least 20% by volume, based on the total volume of the powder coating composition. The core-shell polymer may be present in the powder coating composition, if at all, in an amount of no more than 30% by volume, such as no more than 25% by volume, such as no more than 20% by volume, such as no more than 15% by volume, based on the total volume of the powder coating composition. The core-shell polymer may be present in an amount of 1% to 30% by volume, such as 1% to 25% by volume, such as 5% to 20% by volume, such as 10% to 15% by volume, based on the total volume of the powder coating composition.

The powder coating composition of the present invention may comprise, consist essentially of, or consist of a binder comprising, consisting essentially of, or consisting of an epoxy resin; a core/shell polymer; and a thermally conductive, electrically insulative filler material. The thermally conductive, electrically insulative filler material may comprise, consist essentially of, or consist of boron nitride, silicon nitride, aluminum nitride, boron arsenide, aluminum oxide, magnesium oxide, dead burned magnesium oxide, beryllium oxide, silicon dioxide, titanium oxide, zinc oxide, nickel oxide, copper oxide, tin oxide, aluminum hydroxide (i.e., aluminum trihydrate), magnesium hydroxide, boron arsenide, silicon carbide, agate, emery, ceramic microspheres, diamond, or any combination thereof. The thermally conductive, electrically insulative filler material may comprise, consist essentially of, or consist of aluminum hydroxide and/or boron nitride.

The powder coating composition can also include other optional materials. For example, the powder coating compositions can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present invention.

Example colorants include pigments (organic or inorganic), dyes and tints, such as those used in the paint industry and/or listed in the Dry Color Manufacturers Association (DCMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings for example by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), and any mixture thereof.

Example dyes include, but are not limited to, those that are solvent and/or aqueous based such as phthalo green or blue, iron oxide, bismuth vanadate, anthraquinone, and perylene and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions Division of Eastman Chemical, Inc.

Further, the powder coating composition may be substantially free, essentially free, or completely free of a colorant such as a pigment. The term “substantially free of a colorant” means that the coating composition contains less than 1000 parts per million by weight (ppm) of a colorant based on the total solids weight of the composition, “essentially free of a colorant” means that the coating composition contains less than 100 ppm of a colorant based on the total solids weight of the composition, and “completely free of a colorant” means that the coating composition contains less than 20 parts per billion by weight (ppb) of a colorant based on the total solids weight of the composition.

Other non-limiting examples of components that can be used with the powder coating compositions of the present invention include plasticizers, abrasion resistant particles, anti-oxidants, hindered amine light stabilizers, UV light absorbers and stabilizers, surfactants, flow and surface control agents, thixotropic agents, catalysts, reaction inhibitors, corrosion-inhibitors, and other customary auxiliaries. The powder coating compositions can also be substantially free, essentially free, or completely free of any one of the previously described additional components.

The powder coating composition may be substantially free, essentially free, or completely free of silicone. As used herein, a powder coating composition is substantially free of silicone if silicone is present, if at all, in an amount of less than 5% by weight, based on the total weight of the powder coating composition. As used herein, a powder coating composition is essentially free of silicone if silicone is present, if at all, in an amount of less than 1% by weight, based on the total weight of the powder coating composition.

The powder coating composition may be substantially free, essentially free, or completely free of bentonite. As used herein, a powder coating composition is substantially free of bentonite if bentonite is present, if at all, in an amount of less than 0.5% by weight, based on the total weight of the powder coating composition. As used herein, a powder coating composition is essentially free of bentonite if bentonite is present, if at all, in an amount of less than 0.1% by weight, based on the total weight of the powder coating composition.

The powder coating composition may be substantially free, essentially free, or completely free of titanium dioxide. As used herein, a powder coating composition is substantially free of titanium dioxide if titanium dioxide is present, if at all, in an amount of less than 1% by weight, based on the total weight of the powder coating composition. As used herein, a powder coating composition is essentially free of titanium dioxide if titanium dioxide is present, if at all, in an amount of less than 0.1% by weight, based on the total weight of the powder coating composition.

The powder coating composition may be substantially free, essentially free, or completely free of polyol having a melting point of 40 to 110° C. Examples include a polyether polyol, a polyester polyol, a polycarbonate polyol, an acryl polyol, a polycaprolactone polyol, a linear polyol, and a polysiloxane polyol, all of which have a melting point of 40 to 110° C. As used herein, a powder coating composition is substantially free of polyol having a melting point of 40 to 110° C. if polyol having a melting point of 40 to 110° C. is present, if at all, in an amount of less than 5% by weight, based on the total weight of the powder coating composition. As used herein, a powder coating composition is essentially free of polyol having a melting point of 40 to 110° C. if polyol having a melting point of 40 to 110° C. is present, if at all, in an amount of less than 1% by weight, based on the total weight of the powder coating composition.

The powder coating composition may comprise a composition having improved edge coverage. For example, surface tension effects can pull the coating away from sharp edge(s) of the substrate during flow/cure in some circumstances. “Sharp edge(s)” can refer to edges that have been stamped, sheared, machine cut, laser cut and the like. Accordingly, a powder coating composition having improved edge coverage is a composition that reduces the flow of the coating during cure and maintains sufficient coating coverage over the edge. The powder coating composition may comprise a composition comprising film-forming resins and/or additives that improve edge coverage performance of the applied coating over the substrate. These materials have a lower tendency to flow and are able to effectively resist surface tension and remain in place.

The powder coating composition may be prepared by mixing the previously described binder, thermally conductive, electrically insulative filler material, and optional additional components. The components are mixed such that a homogenous mixture is formed. The components can be mixed using art-recognized techniques and equipment such as with a Prism high speed mixer for example. When a solid coating composition is formed, the homogenous mixture is next melted and further mixed. The mixture can be melted with a twin screw extruder, single screw extruder, or a similar apparatus known in the art. During the melting process, the temperatures will be chosen to melt mix the solid homogenous mixture without curing the mixture. The homogenous mixture can be melt mixed in a twin screw extruder with zones set to a temperature of 75° C. to 140° C., 75° C. to 125° C., such as from 85° C. to 115° C., or at 100° C.

After melt mixing, the mixture may be cooled and re-solidified. The re-solidified mixture may then be ground such as in a milling process to form a solid particulate curable powder coating composition. The re-solidified mixture can be ground to any desired particle size. For example, in an electrostatic coating application, the re-solidified mixture can be ground to an average particle size of at least 10 microns or at least 20 microns and up to 130 microns as determined with a Beckman-Coulter LS™ 13 320 Laser Diffraction Particle Size Analyzer following the instructions described in the Beckman-Coulter LS™ 13 320 manual. Further, the particle size range of the total amount of particles in a sample used to determine the average particle size can comprise a range of from 1 micron to 200 microns, or from 5 microns to 180 microns, or from 10 microns to 150 microns, which is also determined with a Beckman-Coulter LS™ 13 320 Laser Diffraction Particle Size Analyzer following the instructions described in the Beckman-Coulter LS™ 13 320 manual.

The present invention is also directed to a method of coating a substrate comprising applying the powder coating composition of the present invention over at least a portion of a substrate. The method may further comprise at least partially curing the applied coating.

The powder coating compositions of the present invention can be applied by any means standard in the art, such as spraying, electrostatic spraying, a fluidized bed process, and the like. After the powder coating compositions are applied to a substrate, the compositions can be cured or at least partially cured such as with heat, or with other means such as actinic radiation to form an at least partially cured coating.

In some examples, the powder coating composition of the present invention is cured with heat, such convection heating within a range of from 250° F. to 500° F. for 2 to 40 minutes, or within a range of from 250° F. to 400° F. for 10 to 30 minutes, or within a range of from 300° F. to 400° F. for 10 to 30 minutes. The powder coating composition of the present invention can also be cured with infrared radiation in which peak metal temperatures can reach 400° F. to 500° F. in about 10 seconds. The elevated heat ramping with infrared radiation allows for fast cure times. In some examples, the powder coating composition of the present invention is cured with infrared radiation to heat the composition within a range of from 300° F. to 550° F. for 1 to 20 minutes, or within a range of from 350° F. to 525° F. for 2 to 10 minutes, or within a range of from 370° F. to 515° F. for 5 to 8 minutes.

It is appreciated that the powder coating composition of the present invention can be cured with multiple types of heat sources such as both convection heating and infrared radiation. For example, the powder coating composition of the present invention can be partially cured with convection heating or infrared radiation, and then completely cured with a different heat source chosen from convection heating and infrared radiation.

The powder coating compositions of the present invention can also be applied in multiple applications over a substrate. For instance, a first powder coating composition according to the present invention can be applied over at least a portion of a substrate. A second powder coating composition according to the present invention can be applied over at least a portion of the first coating composition. The first powder coating composition can optionally be cured or at least partially cured before applying the second powder coating composition. Alternatively, the second powder coating composition can be applied over at least a portion of the first coating composition. The first and second coating composition can then be cured together at the same time. The powder coating compositions can be cured with any of the methods previously described.

Coatings formed from a single powder coating composition according to the present invention can be applied at any desired dry film thickness. For example, the dry film thickness may be at least 2 mils (50.8 microns), such as at least 3 mils (76.2 microns), such as at least 4 mils (101.6 microns), such as at least 5 mils (127 microns), such as at least 6 mils (152.4 microns), such as at least 8 mils (203.2 microns), such as at least 10 mils (254 microns), such as at least 12 mils (304.8 microns), such as at least 20 mils (508 microns), such as at least 40 mils (1,016 microns). For example, the dry film thickness may be less than 40 mils (1,016 microns), such as less than 20 mils (508 microns), such as less than 12 mils (304.8 microns), less than 10 mils (254 microns), less than 8 mils (203.2 microns), or less than 6 mils (152.4 microns), or less 5 mils (127 microns), or less than 4 mils (101.6 microns), or less than 3 mils (76.2 microns), or less than 2 mils (50.8 microns). It is appreciated that, when multiple powder coating compositions are applied, each composition can be applied to separately provide any of the previously described dry film thicknesses. For instance, when two separate powder coating compositions of the present invention are applied, each individual powder coating composition can be applied at any of the previously described dry film thicknesses.

The present invention is also directed to a substrate comprising a coating layer applied from any of the powder coating compositions described herein.

The coating may be a dielectric coating (i.e., an electrically insulating coating). For example, the coating may have a dielectric strength of at least 1 kV at any of the dry film thicknesses described herein, as measured by a Sefelec Dielectrimeter RMG12AC-DC and in accordance ASTM D 149-09 Hipot test, such as at least 2 kV, such as at least 2.5 kV, such as at least 5 kV, such as at least 7 kV, such as at least 8 kV, such as at least 10 kV, such as at least 12 kV, or higher. For example, the coating may have a dielectric strength of at least 2 kV at a dry film thickness of 38.1 microns or less, as measured by a Sefelec Dielectrimeter RMG12AC-DC and in accordance ASTM D 149-09 Hipot test, such as at least 2.5 kV, such as at least 5 kV, such as at least 7 kV, such as at least 8 kV, such as at least 10 kV, such as at least 12 kV, or higher.

The coating may be thermally conductive. For example, the coating may have a thermal conductivity of at least 0.3 W/m·K, as measured according to ASTM D7984, such as at least 0.5 W/m·K, such as at least 0.7 W/m·K, such as at least 0.9 W/m·K, such as at least 1.5 W/m·K, or higher.

The substrate coated with the powder coating composition may be selected from a wide variety of substrates and combinations thereof. Non-limiting examples of substrates include vehicles including automotive substrates, industrial substrates, marine substrates and components such as ships, vessels, and on-shore and off-shore installations, storage tanks, packaging substrates, architectural substrates, aerocraft and aerospace components, batteries and battery components, bus bars, metal wires, copper or aluminum conductors, nickel conductors, wood flooring and furniture, fasteners, coiled metals, heat exchangers, vents, an extrusion, roofing, wheels, grates, belts, conveyors, grain or seed silos, wire mesh, bolts or nuts, a screen or grid, HVAC equipment, frames, tanks, cords, wires, apparel, electronics and electronic components including housings and circuit boards, glass, sports equipment, including golf balls, stadiums, buildings, bridges, containers such as a food and beverage containers, and the like.

The substrates, including any of the substrates previously described, can be metallic or non-metallic. Metallic substrates include, but are not limited to, tin, steel, cold rolled steel, hot rolled steel, steel coated with zinc metal, zinc compounds, zinc alloys, electrogalvanized steel, hot-dipped galvanized steel, galvanealed steel, galvalume, steel plated with zinc alloy, stainless steel, zinc-aluminum-magnesium alloy coated steel, zinc-aluminum alloys, aluminum, aluminum alloys, aluminum plated steel, aluminum alloy plated steel, steel coated with a zinc-aluminum alloy, magnesium, magnesium alloys, nickel, nickel plating, bronze, tinplate, clad, titanium, brass, copper, silver, gold, 3-D printed metals, cast or forged metals and alloys, or combinations thereof.

Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, engineering polymers such as poly(etheretherketone) (PEEK), polycarbonate acrylobutadiene styrene (PC/ABS), polyamide, wood, veneer, wood composite, particle board, medium density fiberboard, cement, stone, glass, paper, cardboard, textiles, leather both synthetic and natural, composite substrates such as fiberglass composites or carbon fiber composites, 3-D printed polymers and composites, and the like.

As used herein, “vehicle” or variations thereof include, but are not limited to, civilian, commercial and military aircraft, and/or land vehicles such as airplanes, helicopters, cars, motorcycles, and/or trucks. The shape of the substrate can be in the form of a sheet, plate, bar, rod or any shape desired.

The substrate can undergo various treatments prior to application of the powder coating composition. For instance, the substrate can be alkaline cleaned, deoxidized, mechanically cleaned, ultrasonically cleaned, solvent wiped, roughened, plasma cleaned or etched, exposed to chemical vapor deposition, treated with an adhesion promoter, plated, anodized, annealed, cladded, or any combination thereof prior to application of the powder coating composition. The substrate can be treated using any of the previously described methods prior to application of the powder coating composition such as by dipping the substrate in a cleaner and/or deoxidizer bath prior to applying the powder coating composition. The substrate can also be plated prior to applying the powder coating composition. As used herein, “plating” refers to depositing a metal over a surface of the substrate. The substrate may be also be 3D printed.

As discussed above, the substrate may comprise a battery or battery component. The battery may be, for example, an electric vehicle battery, and the battery component may be an electric vehicle battery component. The battery component may comprise, but is not limited thereto, a battery cell, a battery shell, a battery module, a battery pack, a battery box, a battery cell casing, a pack shell, a battery lid and tray, a thermal management system, an inverter, a battery housing, a module housing, a module racking, a battery side plate, a battery cell enclosure, a cooling module, a cooling tube, a cooling fin, a cooling plate, a bus bar, a battery frame, an electrical connection, metal wires, or copper or aluminum conductors or cables, or any part of a stationary energy storage system. The powder coating composition may be applied over any of these substrates to form an electrically insulating coating (i.e., dielectric coating), a thermally conductive coating, or an electrically insulating and thermally conductive coating, as described herein.

The coated substrate may comprise a battery component comprising a thermally conductive, electrically insulating coating comprising, consisting essentially of, or consisting of a binder and a thermally conductive, electrically insulating filler material. The thermally conductive, electrically insulating filler material may comprise, consist essentially of, or consist of aluminum hydroxide in the amounts taught herein. For example, the coated substrate may comprise a battery component comprising a thermally conductive, electrically insulating coating comprising, consisting essentially of, or consisting of a binder and aluminum hydroxide present in an amount of at least 20% by weight, such as at least 40% by weight, such as at least 45% by weight, such as at least 50% by weight, based on the total weight of the thermally conductive, electrically insulating coating.

The coated substrate may comprise a battery component comprising a thermally conductive, electrically insulating coating comprising, consisting essentially of, or consisting of a binder and a thermally conductive, electrically insulating filler material comprising, consisting essentially of, or consisting of dead burned magnesium oxide.

The coated substrate may comprise a battery component comprising a thermally conductive, electrically insulating coating comprising, consisting essentially of, or consisting of a binder, a thermoplastic material, and a thermally conductive, electrically insulating filler material.

The coated substrate may comprise a battery component comprising a thermally conductive, electrically insulating coating comprising, consisting essentially of, or consisting of a binder, and at least two thermally conductive, electrically insulating filler material. The at least two thermally conductive, electrically insulating filler material may comprise, consist essentially of, or consist of at least two of aluminum hydroxide, dead burned magnesium oxide, and boron nitride. The binder may comprise, consist essentially of, or consist of an epoxy resin and/or a polyester resin.

As used herein, the term “polymer” refers broadly to oligomers and both homopolymers and copolymers. The term “resin” is used interchangeably with “polymer”.

The terms “acrylic” and “acrylate” are used interchangeably (unless to do so would alter the intended meaning) and include acrylic acids, anhydrides, and derivatives thereof, such as their C₁-C₅ alkyl esters, lower alkyl-substituted acrylic acids, e.g., C₁-C₂ substituted acrylic acids, such as methacrylic acid, 2-ethylacrylic acid, etc., and their C₁-C₄ alkyl esters, unless clearly indicated otherwise. The terms “(meth)acrylic” or “(meth)acrylate” are intended to cover both the acrylic/acrylate and methacrylic/methacrylate forms of the indicated material, e.g., a (meth)acrylate monomer. The term “(meth)acrylic polymer” refers to polymers prepared from one or more (meth)acrylic monomers.

As used herein molecular weights are determined by gel permeation chromatography using a polystyrene standard. Unless otherwise indicated molecular weights are on a weight average basis.

The term “glass transition temperature” or “Tg” is the temperature at which a glass transition occurs, i.e., a reversible transition from hard and relatively brittle glassy state into a viscous or rubbery state. The glass transition temperature may be a measured or theoretical value. For example, the theoretical glass transition temperature of (meth)acrylic polymers may be calculated by the method of Fox on the basis of monomer composition of the monomer charge according to T. G. Fox, Bull. Am. Phys. Soc. (Ser. II) 1, 123 (1956) and J. Brandrup, E. H. Immergut, Polymer Handbook 3^{rd} edition, John Wiley, New York, 1989.

As used herein, unless otherwise defined, the term substantially free means that the component is present, if at all, in an amount of less than 5% by weight, based on the total weight of the powder coating composition.

As used herein, unless otherwise defined, the term essentially free means that the component is present, if at all, in an amount of less than 1% by weight, based on the total weight of the powder coating composition.

As used herein, unless otherwise defined, the term completely free means that the component is not present in the powder coating composition, i.e., 0.00% by weight, based on the total weight of the powder coating composition.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” thermoplastic material, “a” thermally conductive, electrically insulative filler material, “a” non-thermally conductive, electrically insulative filler material, “an” electrically conductive filler material, and “a” dispersant, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a powder coating composition “deposited onto” a substrate does not preclude the presence of one or more other intervening coating layers of the same or different composition located between the powder coating composition and the substrate.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

The powder coating compositions of Example compositions 1-9 were prepared from the components listed below in Table 1 according to the procedure described below:

TABLE 1

| | Comp. | | | | | |
|---|---|---|---|---|---|---|
| Ingredient | Ex 1 | Ex 2 | Ex 3 | Ex 4 | Ex 5 | Ex 6 |
| Pioester | 47.88 | 22.12 | 15.95 | 21.78 | 22.12 | 42.93 |
| 7224 ¹ | | | | | | |
| Joncryl 819 ² | 2.22 | 1.03 | 0.74 | 1.01 | 1.03 | 1.99 |
| NPES-903³ | 43.0 | 19.87 | 14.32 | 19.57 | 19.87 | 38.56 |
| Vestagon | 4.44 | 4.44 | 4.44 | 4.44 | 4.44 | 3.99 |
| BF 1540⁴ | | | | | | |
| PL-200A ⁵ | 0.88 | 0.88 | 0.88 | 0.88 | 0.88 | 0.80 |
| Benzoin⁶ | 0.44 | 0.44 | 0.44 | 0.44 | 0.44 | 0.40 |
| Micromide | 1.00 | 1.00 | 1.00 | 1.00 | 1.00 | 0.90 |
| 520L⁷ | | | | | | |
| Butaflow | 0.12 | 0.06 | 0.06 | 0.06 | 0.06 | 0.10 |
| BT-71⁸ | | | | | | |
| Apyral 30X ⁹ | 0.00 | 50 | 50 | 29.02 | 30.00 | 0.00 |
| Phenoxy | 0.00 | 0.00 | 12.01 | 0.00 | 0.00 | 0.00 |
| PKHB | | | | | | |
| blend¹⁰ | | | | | | |
| Magchem | 0.00 | 0.00 | 0.00 | 21.65 | 0.00 | 0.00 |
| P98 | | | | | | |
| Boron | 0.00 | 0.00 | 0.00 | 0.00 | 0.00 | 10.17 |
| Nitride ¹² | | | | | | |
| Aluminum | 0.00 | 0.00 | 0.00 | 0.00 | 20.00 | 0.00 |
| Nitride ¹⁵ | | | | | | |
| Portafil A- | 0.00 | 0.00 | 0.00 | 0.00 | 0.00 | 0.00 |
| 40 | | | | | | |
| Boron | 0.00 | 0.00 | 0.00 | 0.00 | 0.00 | 0.00 |
| Nitride¹⁴ | | | | | | |
| Disperbyk- | 0.00 | 0.00 | 0.00 | 0.00 | 0.00 | 0.00 |
| 111¹⁶ | | | | | | |
| Aerox Alu | 0.10 | 0.10 | 0.10 | 0.10 | 0.10 | 0.10 |
| C | | | | | | |
| alumina¹¹ | | | | | | |

| Ingredient | Ex 7 | Ex 8 | Ex 9 | Ex 10 | Ex 11 |
|---|---|---|---|---|---|
| Pioester | 42.93 | 36.27 | 36.27 | 31.63 | 31.56 |
| 7224 ¹ | | | | | |
| Joncryl 819 ² | 1.99 | 1.68 | 1.68 | 1.47 | 1.46 |
| NPES-903³ | 38.56 | 32.58 | 32.58 | 28.41 | 28.35 |
| Vestagon | 3.99 | 3.35 | 3.35 | 2.92 | 2.91 |
| BF 1540⁴ | | | | | |
| PL-200A ⁵ | 0.80 | 0.67 | 0.67 | 0.58 | 0.58 |
| Benzoin⁶ | 0.40 | 0.33 | 0.33 | 0.29 | 0.29 |
| Micromide | 0.90 | 0.76 | 0.76 | 0.66 | 0.65 |
| 520L⁷ | | | | | |
| Butaflow | 0.10 | 0.09 | 0.09 | 0.08 | 0.08 |
| BT-71⁸ | | | | | |
| Apyral 30X ⁹ | 0.00 | 27.51 | 0.00 | 33.96 | 33.89 |
| Phenoxy | 0.00 | 0.00 | 0.00 | 0.00 | 0.00 |
| PKHB | | | | | |
| blend¹⁰ | | | | | |
| Magchem | 0.00 | 0.00 | 0.00 | 0.00 | 0.00 |
| P98 | | | | | |
| Boron | 0.00 | 0.00 | 0.00 | 0.00 | 0.00 |
| Nitride ¹² | | | | | |
| Aluminum | 0.00 | 0.00 | 0.00 | 0.00 | 0.00 |
| Nitride ¹⁵ | | | | | |
| Portafil A- | 0.00 | 0.00 | 27.51 | 0.00 | 0.00 |
| 40 | | | | | |
| Boron | 10.17 | | 0.00 | 0.00 | 0.00 |
| Nitride¹⁴ | | | | | |
| Disperbyk- | | | | 0.00 | 0.21 |
| 111¹⁶ | | | | | |
| Aerox Alu | 0.10 | 0.10 | 0.10 | 0.10 | 0.10 |
| C | | | | | |
| alumina¹¹ | | | | | |

¹ Polyester resin from Panolam industries
² Acrylic resin from BASF
³Epoxy resin from NAN YA PLASTICS
⁴Uretdion-butanediol adduct from Evonik CRM
⁵ Acrylic polymer silica mix from Estron Chemical
⁶2-Hydroxy-2-phenylacetophenone from Haungshan Linlu Coatings Materials
⁷Wax additive from Micro powders
⁸Catalyst from Estron Chemical
⁹ Aluminum tri-hydrate from Nabaltec GMBH D50 particle (um) 7
¹⁰Custom blend from Gabriel of PKHB 60% with 40% Epon 2002 from Hexion Specialty Chemicals
¹¹Aluminum oxide from Cabot corporation
¹² Boron Nitride NX1 from Momentive D50 particle (um) 1 um
13 Aluminum trihydrate from Sibelco D50 particle (um) 11.5 um
¹⁴Boron Nitride Polertherm PT100 from Momentive D50 particle 13 um
¹⁵ Aluminum Nitride TFZ-N15P from Toyo Aluminum K.K. D50 particle 15(um)
¹⁶DisperBYK-111 from BYK additives

For each composition, each of the components listed in Table 1 were weighed in a container and mixed in a prism high speed mixer for 15 seconds at 3500 RPM to form a dry homogeneous mixture. The mixture was then melt mixed in a Werner Pfleiderer 19 mm twin screw extruder with an aggressive screw configuration and a speed of 500 RPM. The first zone was set at 50° C., and the second, third, and fourth zones were set at 110° C. The feed rate was such that a torque of 50% was obtained on the equipment for Example 1 and the same feed rate was maintained for the other examples. The extruded material dropped onto a set of chill rolls to cool and re-solidify the mixtures into solid chips. The addition of the post additive listed in Table 1 as aluminum oxide were incorporated with the cooled chips. The chips were milled to a fine powder in a Mikro ACM®-1 Air Classifying Mill to obtain a particle size of 5 to 150 microns with a majority of the particles from 30 to 52 microns. The resulting coating compositions for each of Examples 1 through 11 were solid particulate powder coating compositions that were free flowing.

Application of powder coating for dielectric testing: For dielectric testing, the powder coating compositions were applied with an Encore Nordson powder coating cup gun with a 3 mm flat spray nozzle at 75 kV, amperage restricted at 15-20 mA, 10 psi atomizing and 10 psi conveying flow air. An initial layer was applied at about 100 microns on B1000 P99X cold rolled steel panels from ACT and baked for 5 minutes at 350° F. The hot panels were pulled out of the oven and immediately sprayed with more powder coating to a final coating thickness was between 230 to 247 microns. The final film build obtained on the panels were baked at 350° F. for 30 minutes to form a coating layer for comparative dielectric testing.

Dielectric breakdown testing: Each of the coatings prepared from the compositions of Examples 1-11 were evaluated for dielectric strength, as measured by a Sefelec Dielectric Strength Tester RMG12AC-DC and in accordance with ASTM D149-09 Dielectric Breakdown Voltage and Dielectric Strength test. The parameters of the testing were as follows: Voltage limit 12.0 kV DC, Iₘₐₓ Limit: 0.5 mA, 20 second ramp, 20 second dwell, and 2 second fall. A coating film was considered to pass if it survived to the voltage limit (12 kV) without rupture. If the film ruptured, the voltage at which the rupture occurred was reported. Results are reported in Table 2 below.

Application of powder coating for thermal conductivity testing: Free films for thermal conductivity testing were prepared by coating Teflon plates that are 76 mm wide, 100 mm tall, & 15.3 mm thick with the powder coating compositions. The Teflon plates were preheated for 30 minutes at 350° F. before being the powder coating was applied with an Encore Nordson powder coating cup gun with a 3 mm flat spray nozzle at 75 kV, amperage restricted at 15-20 mA, 10 psi atomizing and 10 psi conveying flow air. Target film thickness was 255 microns, 510 microns and 765 microns+/−75 microns. After application, the films were cured for 30 minutes at 350° F. then allowed to cool. Films were removed from the Teflon plates using a razor blade to work the film edge and lift from panel slightly then inserting a spatula blade under coating film to obtain a free film. Testing disks for thermal-conductivity testing were prepared using a preheated the 1 5/16″ Arch Punch to punch out testing disks of each of the three film thicknesses for each example. Films were laid over a soft block of wood to facilitate easy cutting of the films to the disk shape. Thermal conductivity measurements were made using a Modified Transient Plane Source (MTPS) method (conformed to ASTM D7984) with a TCi thermal conductivity analyzer from C-Therm Technologies Ltd. Results for thermal-conductivity testing are reported in Table 2 below.

TABLE 2

| | Comp. | | | | | | | | | | |
|---|---|---|---|---|---|---|---|---|---|---|---|
| | Ex 1 | Ex 2 | Ex 3 | Ex 4 | Ex 5 | Ex 6 | Ex 7 | Ex 8 | Ex 9 | Ex 10 | Ex 11 |
| Dielectric | Pass | Pass | Pass | Pass | Pass | Pass | Pass | Pass | Pass | Pass | Pass |
| Breakdown | | | | | | | | | | | |
| Thermal | 0.200 | 0.442 | 0.892 | 0.587 | 0.591 | 0.294 | 0.551 | 0.287 | 0.369 | 0.384 | 0.510 |
| Conduct. | | | | | | | | | | | |
| (W/K-m) | | | | | | | | | | | |

As demonstrated in Comparative Example 1, a baseline comparative powder composition has relatively weak thermal conductivity with excellent dielectric properties. Example 2 demonstrates that a 30% loading by volume of aluminum hydroxide filler improves the thermal conductivity of the coating while maintaining passing dielectric strength. Example 3 demonstrates that the addition of a thermoplastic material to a composition with 30% by volume aluminum hydroxide even further improves the thermal conductivity of the coating relative to Example 2 while maintaining dielectric performance. Examples 4 and 5 demonstrate that substituting 10% of the 30% by volume aluminum hydroxide with a dead burned grade of magnesium oxide or aluminum nitride synergistically improves thermal conductivity over the aluminum hydroxide alone while maintaining dielectric performance. Examples 6 and 7 each include boron nitride at 6% by volume loading but include boron nitride at different particle size. Example 7 having the large particle size boron nitride performs better in thermal conductivity than Example 6 having the smaller particle size. we again show that a larger particle size Boron Nitride gives improved thermal conductivity than a smaller particles Boron Nitride at a 6% by volume loading. Likewise, Examples 8 and 9 compare compositions having the same amounts of aluminum hydroxide but with different particle sizes used in each composition. Examples 8 and 9 demonstrate that a smaller particle size aluminum hydroxide example versus a larger particle size in Example 9 shows better thermal conductivity performance than the smaller particle size in Example 8. Examples 10 and 11 demonstrate the adding a dispersant to a 20% by volume aluminum hydroxide composition can improve thermal conductivity without negatively impacting dielectric performance. Each of Examples 2-11 demonstrate improved thermal conductivity without negatively impacting dielectric performance relative to Example 1.

### Examples 12-14

The powder coating compositions of Examples compositions 12-14 were prepared from the components listed below in Table 3 according to the procedure described below:

TABLE 3

| | Comp. | Comp. | Exp. |
|---|---|---|---|
| Component | Ex. 12 | Ex. 13 | Ex. 14 |
| EPON 2004¹ | 290.49 | 196.46 | 175.80 |
| NPES-903 EPOXY | 290.49 | 196.46 | 175.80 |
| RESIN² | | | |
| EPIKURE P-202³ | 122.11 | 82.58 | 73.90 |
| RESIFLOW PL-200A⁴ | 10.00 | 10.00 | 10.00 |
| BENZOIN⁵ | 5.00 | 5.00 | 5.00 |
| LUN AMER MB-68⁶ | 2.00 | 2.00 | 2.00 |
| STAPHYLOID | 0.00 | 0.00 | 50.00 |
| AC-4030⁷ | | | |
| PRINTEX G⁸ | 6.00 | 6.00 | 6.00 |
| BARIMITE 10⁹ | 272.40 | 0.00 | 0.00 |
| PORTAFILL A 40¹⁰ | 0.00 | 500.00 | 500.00 |
| AEROX. ALU | 1.50 | 1.50 | 1.50 |
| C/SPECTR.¹¹ | | | |

¹Epoxy resin commercially available epoxy resin from Hexion Specialty Chemicals
²Commercially available epoxy resin from Nan Ya
³Commercially available phenolic curative from Hexion Specialty Chemicals
⁴Commercially available flow control agent from Estron Chemical
⁵Commercially available degassing agent from Mitsubisi Chemical Corporation
⁶Commercially available salt of polycarboxylic acid with cyclic amidine form Aal Chem
⁷Commercially available core-shell alkylmethacrylate copolymer from Takeda Chemical Industries
⁸Commercially available carbon black pigment from Orion Engineered Carbons
⁹Commercially available barium sulfate from Cimbar Performance Minerals
¹⁰Aluminum hydroxide (ATH) having a D₉₇ particle size of about 36 commercially available from Sibelco
¹¹Commercially available aluminum oxide from Evonik Industries

With the exception of the AEROX. ALU C/SPECTR, each of the components listed in TABLE 3 for Examples 12-14 were weighed in a container and mixed in a Henschel high speed mixer for 30 to 90 seconds at 1500 RPM to form a dry homogeneous mixture. The mixture was then melt mixed in a Werner & Pfleiderer 30 mm twin screw extruder with a speed of 425 RPM. The extruder zones were set at 110° C. The feed rate was such that a torque of 25% was observed on the equipment. The mixtures were dropped onto a set of chill rolls to cool and re-solidify the mixtures into solid chips. The addition of the AEROX. ALU C/SPECTR was incorporated with the cooled chips. The chips were milled in a Bantam Mill to obtain a particle size of predominantly 5 to 100 microns with a majority of the particles being from 15 to 80 microns by volume. The resulting coating compositions for each of Examples 12-14 were solid particulate powder coating compositions that were free flowing.

Each of the solid particulate powder coating compositions of Examples 12-14 were electrostatically sprayed with a Nordson manual spray gun at voltage of 45 kV to 90 kV with a vibratory feed dispenser with 15 to 20 psi flow air onto aluminum substrates. During application, a layer of 2.5 mils was applied and then a bake was done with a conventional oven at 375° F. for 5 minutes. A second layer of 2.5 mils was applied and then a bake was done with a conventional oven at 375° F. for 20 minutes providing a final film thickness of 5.0 mils.

Each of the coatings prepared from the compositions were evaluated for dielectric strength, as measured by a Sefelec Dielectric Strength Tester RMG12AC-DC and in accordance with ASTM D149-09 Dielectric Breakdown Voltage and Dielectric Strength test. The parameters of the testing were as follows: Voltage limit 12.0 kV DC, Iₘₐₓ Limit: 0.5 mA, 20 second ramp, 20 second dwell, and 2 second fall. The results of the dielectric strength test are included in TABLE 4:

TABLE 4

| | Comp. | Comp. | Exp. |
|---|---|---|---|
| | Ex. 12 | Ex. 13 | Ex. 14 |
| Dielectric Breakdown | >12 | >12 | >12 |
| (kV) | | | |

Films for thermal conductivity testing were prepared by spray coating plates that are 4 inches wide and 12 inches tall with the powder coating compositions and then a bake was done with a conventional oven at 375° F. for 20 minutes providing coatings of three different thickness from 4 to 12 mils. The coatings were lifted from the plates to obtain a film. Disks were prepared but using a 1 5/16″ Arch Punch to punch out testing disks of each film thickness. Three disks of a different thickness were evaluated for thermal conductivity, as measured by a Thermal Interface Material Tester 1300/1400 and in accordance with ASTM D7984 and are below in Table 5:

TABLE 5

| | Comp. | Comp. | Exp. |
|---|---|---|---|
| | Ex. 12 | Ex. 13 | Ex. 14 |
| % TC/EI Filler by wt. | 0 | 50 | 50 |
| Thermal Conductivity | 0.25 | 0.65 | 0.74 |
| (W/m-K) | | | |

As demonstrated by the results in Table 5, the addition of the thermally conductive, electrically insulative filler material increased the thermal conductivity of both Comparative Example 13 and Experimental Example 14, but Experimental Example 14 that included the core-shell polymer demonstrated an increase in thermal conductivity relative to the Comparative Example 13 at the same filler loading level.

### Examples

The powder coating compositions of Examples compositions 15-16 were prepared from the components listed below in Table 6 according to the procedure described below:

TABLE 6

| | Comp. | Exp. |
|---|---|---|
| Component | Ex. 15 | Ex. 16 |
| EPON RESIN 2004¹ | 290.49 | 268.76 |
| NPES-903 EPOXY | 290.49 | 268.76 |
| RESIN² | | |
| EPIKURE P-202³ | 122.11 | 112.98 |
| RESIFLOW PL-200A⁴ | 10.00 | 10.00 |
| BENZOIN⁵ | 5.00 | 5.00 |
| LUN AMER MB-68⁶ | 2.00 | 2.00 |
| PHENOXY RESIN | 0.00 | 50.00 |
| BLEND⁷ | | |
| PRINTEX G⁸ | 6.00 | 6.00 |
| PORTAFILL A 40⁹ | 272.40 | 275.00 |
| AEROX. ALU | 1.50 | 1.50 |
| C/SPECTR.¹⁰ | | |

¹Epoxy resin commercialy available epoxy resin from Hexion Specialty Chemicals
²Commercially available epoxy resin from Nan Ya
³Commercially available phenolic curative from Hexion Specialty Chemicals
⁴Commercially available flow control agent from Estron Chemical
⁵Commercially available degassing agent from Mitsubishi Chemical Corporation
⁶Commercially available matting agent form Aal Chem
⁷Commercially available PKHB-XLV phenoxy resin from Gabriel Performance Products
⁸Commercially available carbon black pigment from Orion Engineered Carbons
⁹Aluminum hydroxide (ATH) having a D₉₇ particle size of about 36 commercially available from Sibelco
¹⁰Commercially available aluminum oxide from Evonik Industries

Each of the components listed in TABLE 6 for Examples 15-16 were weighed in a container and mixed in a Henschel high speed mixer for 30 to 90 seconds at 1500 RPM to form a dry homogeneous mixture. The mixture was then melt mixed in a Werner & Pfleiderer 30 mm twin screw extruder with a speed of 425 RPM. The extruder zones were set at 110° C. The feed rate was such that a torque of 25% was observed on the equipment. The mixtures were dropped onto a set of chill rolls to cool and re-solidify the mixtures into solid chips. The addition of the post additive listed in Table 1 as aluminum oxide was incorporated with the cooled chips. The chips were milled in a Bantam Mill to obtain a particle size of predominantly 5 to 100 microns with a majority of the particles being from 15 to 80 microns by volume. The resulting coating compositions for each of Examples 15-16 were solid particulate powder coating compositions that were free flowing.

Each of the solid particulate powder coating compositions of Examples 15-16 were electrostatically sprayed with a Nordson manual spray gun at voltage of 45 kV to 90 kV with a vibratory feed dispenser with 15 to 20 psi flow air onto aluminum substrates. During application, a layer of 2.5 mils was applied and then a bake was done with a conventional oven at 375° F. for 5 minutes. A second layer of 2.5 mils was applied and then a bake was done with a conventional oven at 375° F. for 20 minutes providing a final film thickness of 5.0 mils.

Each of the coatings prepared from the compositions were evaluated for dielectric strength, as measured by a Sefelec Dielectric Strength Tester RMG12AC-DC and in accordance with ASTM D149-09 Dielectric Breakdown Voltage and Dielectric Strength test. The parameters of the testing were as follows: Voltage limit 12.0 kV DC, Iₘₐₓ Limit: 0.5 mA, 20 second ramp, 20 second dwell, and 2 second fall. The results of the dielectric strength test are included in TABLE 7:

TABLE 7

| | Comp. | Exp. |
|---|---|---|
| | Ex. 15 | Ex. 16 |
| Dielectric Breakdown | >12 | >12 |
| (kV) | | |

Films for thermal conductivity testing were prepared by spray coating plates that are 4 inches wide and 12 inches tall with the powder coating compositions and then a bake was done with a conventional oven at 375° F. for 20 minutes providing coatings of three different thickness from 4 to 12 mils. The coatings were lifted from the plates to obtain a film. Disks were prepared but using a 1 5/16″ Arch Punch to punch out testing disks of each film thickness. Three disks of a different thickness were evaluated for thermal conductivity, as measured by a Thermal Interface Material Tester 1300/1400 and in accordance with ASTM D7984 and are below in Table 8:

TABLE 8

| | Comp. | Exp. |
|---|---|---|
| | Ex. 1 | Ex. 2 |
| Thermal Conductivity | 0.25 | 0.33 |
| (W/m-K) | | |

Coatings for heat and humidity and dielectric breakdown testing were prepared by spray coating panels that are 4 inches wide and 12 inches tall with the powder coating compositions. First a layer of 2.5 mils was applied to the panel front and back and then a bake was done with a conventional oven at 375° F. for 5 minutes. A second layer of 2.5 mils was applied to the panel front and back and then a bake was done with a conventional oven at 375° F. for 20 minutes providing a final film thickness of 5.0 mils. The coated panels were exposed to heat and humidity, 85° C. and 85% RH, for 1,500 hours. After the heat and humidity exposure was completed, each of the coatings prepared from the compositions were evaluated for dielectric strength, The differences between post heat and humidity dielectric strength and pre heat and humidity dielectric strength on a percentage basis are below in Table 9:

TABLE 9

| | Comp. | Exp. |
|---|---|---|
| | Ex. 1 | Ex. 2 |
| Delta Dielectric | 29.2 | 9.2 |
| Breakdown (%) | | |

As demonstrated in Table 9, the inclusion of the phenoxy resin resulted in significantly less change in the dielectric breakdown performance of the powder coating following heat and humidity testing compared to the comparative powder coating that did not include the phenoxy resin. This was an unexpected result.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. A powder coating composition comprising:
a binder;
a thermally conductive, electrically insulative filler material; and
a thermoplastic material.

2. The powder coating composition of claim 1, wherein the thermoplastic material comprises a phenoxy resin.

3. The powder coating composition of claim 1, wherein the thermoplastic material has a melt temperature (Tm) of at least 50° C.

4. The powder coating composition of claim 1, wherein the thermoplastic material has a glass transition temperature (Tg) of at least −30° C.

5. The powder coating composition of claim 1, wherein the thermoplastic material has a melt index at 200° C. of at least at least 40 g/10 min.

6. The powder coating composition of claim 1, wherein the thermoplastic material has a melt viscosity at 200° C. of at least 90 Poise.

7. (canceled)

8. The powder coating composition of claim 1, wherein the thermoplastic material has a weight average molecular weight of 15,000 to 1,000,000 g/mol, or a number average molecular weight of 5,000 to 100,000 g/mol.

9. (canceled)

10. The powder coating composition of claim 1, wherein the thermoplastic material comprises a hydroxyl functional group.

11. (canceled)

12. The powder coating composition of claim 10, wherein the thermoplastic material has a hydroxyl equivalent weight of 200 to 500,000 g/equivalent.

13. The powder coating composition of claim 1, wherein the thermoplastic material is present in an amount of 0.5% to 20% by weight, based on the total weight of the powder coating composition, or the thermoplastic material is present in an amount of 1% to 30% by volume, based on the total volume of the powder coating composition.

14. (canceled)

15. The powder coating composition of claim 1, further comprising a core-shell polymer.

16. A powder coating composition comprising:
a binder;
a thermally conductive, electrically insulative filler material; and
a core-shell polymer.

17-22. (canceled)

23. The powder coating composition of claim 1, wherein the binder comprises a film-forming resin comprising a (meth)acrylate resin, a polyurethane, a polyester, a polyamide, a polyether, a polysiloxane, an epoxy resin, a vinyl resin, copolymers thereof, and/or combinations thereof.

24. The powder coating composition of claim 1, wherein the binder comprises a film-forming resin comprising an epoxy resin.

25. The powder coating composition of claim 1, wherein the binder comprises a film-forming resin comprising an epoxy resin and a polyester resin.

26. The powder coating composition of claim 1, wherein the binder further comprises a crosslinker comprising a phenolic resin, an amino resin, an epoxy resin, a triglycidyl isocyanurate, a beta-hydroxy (alkyl)amide, an alkylated carbamate, a (meth)acrylate, a salt of a polycarboxylic acid with cyclic amidine, o-tolyl biguanide, an isocyanate, a blocked isocyanate, a polyacid, an anhydride, an organometallic acid-functional material, a polyamine, a polyamide, an aminoplast, a carbodiimide, an oxazoline, and/or combinations thereof.

27. The powder coating composition of claim 1, wherein the thermally conductive, electrically insulative filler material comprises boron nitride, silicon nitride, aluminum nitride, boron arsenide, aluminum oxide, magnesium oxide, dead burn magnesium oxide, beryllium oxide, silicon dioxide, titanium oxide, zinc oxide, nickel oxide, copper oxide, tin oxide, aluminum hydroxide, magnesium hydroxide, boron arsenide, silicon carbide, agate, emery, ceramic microspheres, diamond, or any combination thereof.

28. The powder coating composition of claim 1, wherein the thermally conductive, electrically insulative filler material comprises aluminum hydroxide present in an amount of at least 40% by weight, based on the total weight of the powder coating composition.

29. The powder coating composition of claim 1, wherein the thermally conductive, electrically insulative filler material comprises dead burned magnesium oxide.

30. (canceled)

31. The powder coating composition of claim 1, wherein the thermally conductive, electrically insulative filler material comprises boron nitride present in an amount of greater than 40% and less than 50% by weight, based on the total weight of the powder coating composition.

32. The powder coating composition of claim 1, wherein the thermally conductive, electrically insulative filler material comprises at least two of aluminum hydroxide, dead burned magnesium oxide, and boron nitride.

33. (canceled)

34. The powder coating composition of claim 1, wherein the thermally conductive, electrically insulative filler material comprises dead burned magnesium oxide and boron nitride.

35-53. (canceled)

54. A method of coating a substrate comprising applying the powder coating composition of claim 1 over at least a portion of a substrate.

55. (canceled)

56. A substrate comprising a coating layer applied from the powder coating composition of claim 1.

57-75. (canceled)
